(19) United States
(12) Patent Application Publication
(10) Pub. No.: US 2006/0061610 A1
(43) Pub. Date: Mar. 23, 2006

(54) Image forming apparatus

(75) Inventor: Setsuji Tatsumi, Ashigara-Kami-Gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/226,436

(22) Filed: Sep. 15, 2005

(30) Foreign Application Priority Data
Sep. 17, 2004 (JP) 2004-271834
Sep. 28, 2004 (JP) 2004-282652
Sep. 28, 2004 (JP) 2004-282653
Sep. 28, 2004 (JP) 2004-282654

(51) Int. Cl. B41J 29/38; B41J 2/06

(52) U.S. Cl. 347/13; 347/55

(57) ABSTRACT

The image forming apparatus comprises: a long liquid droplet ejection head in which a plurality of nozzles are arranged; a conveyance device which attracts a recording medium by means of electrostatic attraction and conveys the recording medium in a sub-scanning direction substantially perpendicular to a main scanning direction; a dividing device which divides a print region into a plurality of blocks, the blocks including a first blocks and a second blocks situated next to the first blocks in the sub-scanning direction; and a control device which drives, at a substantially simultaneous drive timing, a plurality of mutually adjacent nozzles corresponding to the plurality of blocks, wherein a boundary line that divides the print region in the first blocks in the main scanning direction and a boundary line that divides the print region in the second blocks in the main scanning direction are discontinuous from each other in the sub-scanning direction.

### BACKGROUND OF THE INVENTION

1. Field of the Invention

The present invention relates to an image forming apparatus and more particularly to an image forming apparatus having a liquid droplet ejection head which ejects liquid droplets onto a recording medium.

2. Description of the Related Art

There are inkjet image recording apparatuses which have a long print head (line head) in which a plurality of nozzles are arranged through the width direction of a recording medium, and which form an image on a recording medium at high speed by ejecting liquid droplets from the nozzles onto the recording medium while conveying the recording medium relatively to the print head.

In an image forming apparatus of this kind, if the recording medium is conveyed by being attracted to a conveyance belt by means of electrostatic attraction, then the liquid droplets in flight ejected from adjacent nozzles 51A and 51B respectively become charged as shown in FIG. 21. Therefore, the liquid droplets in flight in the vicinity of each other are mutually repelled due to an electrostatic force of repulsion F, and they separate from each other in flight and land at displaced positions on the recording medium.

In particular, in contrast to a serial head, a line head that is in a fixed state in the width direction of the recording medium forms an image on a recording medium, rather than being scanned in the width direction of the recording medium. Therefore, if the landing positions of the flight liquid droplets are shifted out of position due to the effects of the electrostatic force of repulsion from the flight liquid droplet ejected from adjacent nozzles, then width direction or another type of unevenness is readily visible in the conveyance direction on the recording medium. Consequently, print quality may decline.

Therefore, various technologies have been proposed in order to reduce the visibility of the stripes and the unevenness of this kind (see Japanese Patent Application Publication No. 2001-260342 and Japanese Patent Application Publication No. 2004-42472 as examples).

In Japanese Patent Application Publication No. 2001-260342 discloses a droplet ejection control method which implements dispersion ejection whereby nozzle groups selected discretely are driven substantially simultaneously, the distance between the flight liquid droplets ejected substantially simultaneously is increased, and hence the effects of electrostatic repulsion between the flight liquid droplets are reduced. Thus, displacement of the landing positions is prevented and the visibility of the stripes in the paper conveyance direction is reduced.

Japanese Patent Application Publication No. 2004-42472 discloses the recording apparatus adopting a droplet ejection control method that either all of the nozzles corresponding to a solid print section are driven substantially simultaneously, or two nozzles adjacent to a particular defective nozzle are driven substantially simultaneously, rather than performing disperse ejection as described in Japanese Patent Application Publication No. 2001-260342, if there are nozzles which cannot eject ink due to an electrical disconnection, ink blockage, or the like, (defective nozzles). Hence the effect of electrostatic repulsion between the flight liquid droplets is used to reduce the visibility of the stripes in the paper conveyance direction caused by the defective nozzles.

There may be variation in the direction of flight of the flight ink droplets ejected from the nozzles due to various causes, such as manufacturing variations between the nozzles (positional variations, processing variations in the ejection ports, and the like), foreign matter (soiling) adhering to the vicinity of the ejection ports of the nozzles, irregularity in the ink properties (viscosity, etc.). As the result of that, displacement of their landing positions on the recording medium may occur. When a print head has a nozzle which produces landing position displacement of this kind which is intrinsic to the nozzle, then if printing is performed using the droplet ejection control method disclosed in Japanese Patent Application Publication No. 2001-260342 or Japanese Patent Application Publication No. 2004-42472, stripes or unevenness such as that described below may be visible, leading to a decline in print quality.

FIG. 17 is an illustrative diagram showing print results in a case where solid printing is performed by using the droplet ejection control method disclosed in Japanese Patent Application Publication No. 2001-260342. The nozzle 51-6 is a nozzle producing landing position displacement, which causes the droplet to land in a position deflected toward nozzle 51-7. Hereinafter, the droplet ejection sequence of the nozzles 51-1, . . . , 51-12 corresponding to the solid area 130 is described with reference to FIG. 17.

When the nozzles 51-1, 51-5 and 51-9 eject droplets at the initial drive timing, dots 100-1, 100-5 and 100-9 are formed. When the nozzles 51-2, 51-6 and 51-10 eject droplets at the next drive timing, dots 100-2, 100-6 and 100-10 are formed. In this case, the positions at which the dots 100-2, 100-6 and 100-10 are formed in the paper conveyance direction (sub-scanning direction) are slightly displaced toward the upstream side in the sub-scanning direction (the downward direction in FIG. 17), in comparison with the dots 100-1, 100-5 and 100-9. When nozzles 51-3, 51-7 and 51-11 eject droplets at the next drive timing, dots 100-3, 100-7 and 100-11 are formed, and when nozzles 51-4, 51-8 and 51-12 eject droplets at the next drive timing after that, the dots 100-4, 100-8 and 100-12 are formed. Thereafter, the nozzles 51-1, . . . , 51-12 successively perform droplet ejection in a similar manner.

If droplets are ejected in a droplet ejection sequence of this kind, then there is a large distance between the liquid droplets which are ejected substantially simultaneously. As the result of that, the effect of the force of electrostatic repulsion between flight liquid droplets is reduced and displacement of the landing positions due to electrostatic repulsion is prevented. However, if there is a nozzle 51-6 producing a landing position displacement that is intrinsic to the nozzle, then as shown in FIG. 17, stripes or unevenness in the sub-scanning direction may become visible between the column of dots 120-6 formed by the nozzle 51-6 producing landing position displacement, and the column of dots 120-5 formed by the adjacent nozzle 51-5 which is on the opposite side to the direction of the landing position displacement.

With the droplet ejection control method disclosed in Japanese Patent Application Publication No. 2001-260342, disperse ejection is carried out so that there is no effect of electrostatic repulsion between the flight droplets, as also specified in Japanese Patent Application Publication No. 2004-42472. Therefore, the visibility of stripes or unevenness produced by landing position displacement that is intrinsic to a nozzle is not diminished.

FIG. 18 is an illustrative diagram showing print results in a case where solid printing is performed by using the droplet ejection control method disclosed in Japanese Patent Application Publication No. 2004-42472. The nozzle 51-6 is a nozzle producing landing position displacement, which causes the droplet to land in a position deflected toward nozzle 51-7.

If the nozzles 51-1, . . . , 51-12 corresponding to a solid area 130 eject droplets at the substantially same drive timing, then each of the flight liquid droplets from the nozzles 51-1, . . . , 51-12 receives the effects of forces of electrostatic repulsion F, from the flight liquid droplets ejected from adjacent nozzles (see FIG. 21). However, if at least the three adjacent nozzles 51A, 51B and 51C shown in FIG. 22 eject droplets at substantially simultaneously timings, then although the flight liquid droplet from the middle nozzle 51B receives forces of electrostatic repulsion F from the flight liquid droplets of the nozzles 51A and 51C on either side, the effects of these forces are cancel each other out. Hence, the liquid droplet from the nozzle 51B lands at the intended landing position directly below nozzle 51B.

Therefore, as shown in FIG. 18, the dot columns 120-2, . . . , 120-11 (excluding dot column 120-6), which are formed by the nozzles 51-2, . . . , 51-11 (excluding nozzle 51-6) that correspond to the parts of the solid area 130 apart from the edge sections thereof, are formed in the original intended landing positions in the direction (main scanning direction) which is substantially perpendicular to the conveyance direction of the recording medium.

A flight liquid droplet from the nozzle 51-6 producing a landing position displacement is affected by forces of electrostatic repulsion from the flight liquid droplets ejected from the adjacent nozzles 51-5 and 51-7 on either side. Since the distance between the liquid droplet from the nozzle 51-6 and the flight liquid droplet from the nozzle 51-7 located in the direction of the landing position displacement is shorter, the force of electrostatic repulsion from the flight liquid droplet ejected from the nozzle 51-7 is greater than that from the flight liquid droplet ejected from the nozzle 51-5. Therefore, the dot column 120-6 formed by the nozzle 51-6 producing landing position displacement is shifted in such a manner that it returns toward the originally intended landing position in the main scanning direction. Hence, the visibility of stripes or unevenness occurring between the dot column 120-5 and dot column 120-6 is reduced, compared to the case shown in FIG. 17.

On the other hand, the nozzles 51-1 and 51-12 corresponding to the edge sections of the solid portion 130 only have adjacent nozzles 51-2 and 51-11 located respectively on one side thereof. Therefore, the dot column 120-1 formed by the nozzle 51-1 is shifted to the opposite side from the dot column 120-2 formed by the adjacent nozzle 51-2, and the dot column 120-12 formed by the nozzle 51-12 is shifted to the opposite side from the dot column 120-11 formed by the adjacent nozzle 51-11. Consequently, stripes or unevenness becomes visible between the dot column 120-1 and dot column 120-2, and between the dot column 120-11 and dot column 120-12, and hence blurring may be observed at either edge of a solid area 130 in the main scanning direction thereof.

In this way, in the droplet ejection control method disclosed in Japanese Patent Application Publication No. 2004-42472, if all of the nozzles corresponding to the solid area 130 are driven substantially simultaneously and it is sought to reduce the visibility of stripes or unevenness caused by a defective nozzle or a nozzle producing landing position displacement, then blurring or thickening becomes visible at the edges of the boundary regions of the solid area 130 in the main scanning direction, with the result of that print quality may decline.

Moreover, in the droplet ejection control method disclosed in Japanese Patent Application Publication No. 2004-42472, there is a tendency for the power required to drive all of the nozzles corresponding to the solid area 130 at the substantially same drive timing (namely, the simultaneous drive power) to become large, and hence the simultaneous drive power may be insufficient. Consequently, there may be cases where it is not possible to drive all of the nozzles corresponding to the solid area 130 at the substantially same drive timing, and hence stripes or unevenness in the sub-scanning direction caused by a nozzle producing landing position displacement that is intrinsic to the nozzle may become visible.

Japanese Patent Application Publication No. 2004-42472 discloses a droplet ejection control method for ejecting droplets from both nozzles adjacent to an identified defective nozzle, at the substantially simultaneous times. However, in contrast to a defective nozzle, it is difficult to identify, in real time, a nozzle producing landing position displacement that is intrinsic to the nozzle. Therefore, this method is difficult to apply in such cases.

Furthermore, in order to facilitate understanding of the effects of the third embodiment of the present invention described hereinafter, a case where there are five nozzles is described below, although this description partially duplicates the description given above.

FIG. 19 is an illustrative diagram showing printing results based on the droplet ejection control method described in Japanese Patent Application Publication No. 2001-260342. The nozzle 51-3 is a nozzle producing landing position displacement, which causes the droplet to be deflected toward nozzle 51-4. Below, the drive timings of the nozzles 51-1, 51-2, 51-3, 51-4 and 51-5 are described with reference to FIG. 19.

The nozzles 51-1 and 51-5 eject droplets at the first drive timing, and the nozzle 51-2 ejects a droplet at the second drive timing which is slightly delayed from the first drive timing. Subsequently, the nozzle 51-3 ejects a droplet at a third drive timing which is slightly delayed from the second drive timing, and the nozzle 51-4 ejects a droplet at a fourth drive timing which is slightly delayed from the third drive timing.

In FIG. 19, the flight liquid droplets ejected at different drive timings are not mutually subjected to the effects of electrostatic repulsion. The liquid droplets receive a force of electrostatic repulsion if droplets have been ejected from adjacent nozzles of the flight liquid droplets ejected at the same drive timing, and the liquid droplets do not receive a force of electrostatic repulsion if droplets have been ejected from nozzles other than the adjacent nozzles.

Since the nozzles 51-1 and 51-5, which eject droplets at the first drive timing, are not adjacent to each other, the flight liquid droplets from these nozzles are not subjected to electrostatic repulsion. Therefore, dots 100-1 and 100-5 are formed respectively at the originally intended landing positions in the main scanning direction (in other words, positions directly below the nozzles 51-1 and 51-5 in FIG. 19). Since the nozzles 51-1 and 51-5 eject droplets at the substantially same drive timing, the positions in the sub-scanning direction of the dots 100-1 and 100-5 are substantially the same.

Similarly, the flight liquid droplets from the nozzles 51-2, 51-3 and 51-4 which respectively eject droplets at the second to fourth drive timings are not affected by electrostatic repulsion. In this case, the nozzle 51-3 is a nozzle producing landing position displacement, and therefore, the flight liquid droplets from this nozzle are deflected toward the nozzle 51-4 located in the direction of the landing position displacement. Consequently, dots 100-2 and 100-4 are formed respectively by nozzles 51-2 and 51-4 in their originally intended landing positions in the main scanning direction (namely, positions directly below the nozzles 51-2 and 51-4 in FIG. 19), and furthermore, a dot 100-3 is formed by the nozzle 51-3, which produces landing position displacement, in a position which is displaced toward the nozzle 51-4 from the originally intended landing position in the main scanning direction (namely, a position directly below the nozzle 51-3 in FIG. 19). The positions of the dots 100-2, 100-3 and 100-4 in the sub-scanning direction are displaced slightly toward the upstream side in the sub-scanning direction (paper conveyance direction) from the dots 100-1 and 100-5, due to the time delay between the drive timings of the respective nozzles.

In this way, a dot row 160-0 arranged in the main scanning direction is formed. Following this, dot rows 160-1, . . . , 160-9 are formed successively, as in the case of the dot row 160-0.

In FIG. 19, the numerals indicated inside each dot indicate the sequence of the drive timing of each dot in the respective dot rows 160-0, . . . , 160-9 arranged in the main scanning direction, and dots containing the same numeral in the main scanning direction (for example, dot 100-1 and dot 100-5, and the like) are ejected at the same drive timing.

As the result, the dot columns 120-1, 120-2, 120-4 and 120-5 in the sub-scanning direction are formed respectively by the nozzles 51-1, 51-2, 51-4 and 51-5, at their originally intended landing positions in the main scanning direction, and the dot column 120-3 in the sub-scanning direction is formed by the nozzle 51-3 producing landing position displacement at a position shifted toward the nozzle 51-4. Therefore, stripes or unevenness 140 in the sub-scanning direction caused by the nozzle 51-3 producing landing position displacement that is intrinsic to the nozzle becomes visible between the dot column 120-2 and the dot column 120-3 in the sub-scanning direction.

FIG. 20 is an illustrative diagram showing printing results based on the droplet ejection control method described in Japanese Patent Application Publication No. 2004-47472. The nozzle 51-3 is a nozzle producing landing position displacement, from which the droplet is deflected toward nozzle 51-4. Hereinafter, the drive timings of the nozzles 51-1, 51-2, 51-3, 51-4 and 51-5 are described with reference to FIG. 20.

The nozzles 51-1, 51-2, 51-3, 51-4 and 51-5 eject droplets at the first drive timing. From the second drive timing onward, the nozzles 51-1, 51-2, 51-3, 51-4 and 51-5 also eject droplets, as in the case of the first drive timing.

If the adjacent nozzles 51A and 51B eject droplets substantially simultaneously, as shown in FIG. 21, the flight liquid droplets from the nozzles 51A and 51B are affected by forces of electrostatic repulsion F, and they move away from each other and land at deflected positions on the recording medium. Furthermore, if the three adjacent nozzles 51A, 51B and 51C shown in FIG. 22 eject droplets at substantially simultaneously timings, then the effects of the forces of electrostatic repulsion F, on the flight liquid droplet ejected from the middle nozzle 51B, from the flight liquid droplets of the nozzles 51A and 51C on either side cancel each other out. Consequently, the liquid droplet from nozzle 51B lands at the originally intended landing position directly below nozzle 51B.

At the first drive timing, the flight liquid droplets from the nozzles 51-1 and 51-5 positioned at the edges of the group of nozzles which eject droplets substantially simultaneously are respectively affected by forces of electrostatic repulsion from the flight liquid droplets ejected from the adjacent nozzles 51-2 and 51-4. Therefore, dots 100-1 and 100-5 are formed at positions which are separated from the dots 100-2 and 100-4 with respect to the originally intended landing positions in the main scanning direction (namely, positions directly below the nozzles 51-1 and 51-5 in FIG. 20).

Furthermore, of the nozzles 51-2, 51-3 and 51-4 which are not positioned at the edges of the nozzle group which ejects droplets substantially simultaneously, the effects of electrostatic repulsion are cancelled out on the flight liquid droplets of the nozzles 51-2 and 51-4, excluding the nozzle 51-3 producing landing position displacement. Consequently, dots 100-2 and 100-4 are formed respectively at the originally intended landing positions in the main scanning direction by the nozzles 51-2 and 51-4 (namely, positions directly below the nozzles 51-2 and 51-4 in FIG. 20).

A flight liquid droplet from the nozzle 51-3 producing landing position displacement is affected by forces of electrostatic repulsion from the flight liquid droplets ejected from the adjacent nozzles 51-2 and 51-4 on either side. Since the distance between the liquid droplet from the nozzle 51-3 and the flight liquid droplet from the nozzle 51-4 located in the direction of the landing position displacement is shorter, the force of electrostatic repulsion from the flight liquid droplet ejected from the nozzle 51-4 is greater than that from the flight liquid droplet ejected from the nozzle 51-2. Hence, the position in the main scanning direction at which the dot 100-3 is formed by the nozzle 51-3 producing landing position displacement is shifted toward the dot 100-2 as shown in FIG. 20, in comparison with the position at which the dot 100-3 is formed as shown in FIG. 19 where droplets are ejected without being affected by forces of electrostatic repulsion.

In this way, a dot row 160-0 comprising the dots 100-1, 100-2, 100-3, 100-4 and 100-5 arranged in the main scanning direction is formed at the first drive timing. Subsequently dot rows 160-1, . . . , 160-9 are formed successively, as in the case of the dot row 160-0. As the result, as shown in FIG. 20, dot columns 120-1, 120-2, 120-3, 120-4 and 120-5 arranged in the sub-scanning direction are formed.

In this case, since the width in the main scanning direction of the stripes or unevenness 140 between the dot column 120-3 in the sub-scanning direction formed by the nozzle 51-3 producing landing position displacement and the adjacent dot column 120-2 in the sub-scanning direction is less than in the case shown in FIG. 19, the visibility of the stripes or unevenness 140 in the sub-scanning direction caused by the nozzle 51-3 producing landing position displacement is reduced. Due to the effects of the forces of electrostatic repulsion when the nozzles 51-1, . . . , 51-5 eject droplets substantially simultaneously, new stripes or unevenness 150 in the sub-scanning direction becomes visible respectively between the dot column 120-1 and the dot column 120-2 in the sub-scanning direction, and between the dot column 120-4 and the dot column 120-5 in the sub-scanning direction. Consequently, print quality may decline.

### SUMMARY OF THE INVENTION

The present invention has been contrived in view of the foregoing circumstances, an object thereof being to provide an image forming apparatus which reduces the visibility of stripes or unevenness caused by variation in the landing position which is intrinsic to a nozzle.

In order to attain the aforementioned object, the present invention is directed to an image forming apparatus, comprising: a long liquid droplet ejection head in which a plurality of nozzles are arranged; a conveyance device which attracts a recording medium by means of electrostatic attraction and conveys the recording medium in a sub-scanning direction substantially perpendicular to a main scanning direction; a dividing device which divides a print region into a plurality of blocks, the blocks including a first blocks and a second blocks situated next to the first blocks in the sub-scanning direction; and a control device which drives, at a substantially simultaneous drive timing, a plurality of mutually adjacent nozzles corresponding to the plurality of blocks, wherein a boundary line that divides the print region in the first blocks in the main scanning direction and a boundary line that divides the print region in the second blocks in the main scanning direction are discontinuous from each other in the sub-scanning direction.

According to the present invention, the boundary lines which divide the print region between the first blocks and between the second blocks in the main scanning direction are not continuous in the sub-scanning direction. Hence, if the nozzles corresponding to each block are driven substantially simultaneously, then stripes or unevenness that can arise in the sub-scanning direction at the boundary regions which divide the print region between the blocks in the main scanning direction, is not continuous between the blocks which are mutually adjacent in the sub-scanning direction. Therefore, the visibility of stripes or unevenness in the whole print region is reduced.

By dividing the print region into the plurality of the blocks and driving the nozzles corresponding to each block substantially simultaneously, then even if there is a nozzle producing landing position displacement which is intrinsic to the nozzle and is difficult to be identified, the flight liquid droplets from that nozzle producing landing position displacement are deflected in landing on the recording medium and caused to return toward their original landing positions in the main scanning direction due the effects of electrostatic repulsion. Hence, the visibility of stripes or unevenness in the sub-scanning direction caused by a nozzle producing landing position displacement that is intrinsic to the nozzle is reduced.

Preferably, a drive timing of each of the blocks is different from a drive timing of at least another of the blocks situated in the main scanning direction.

According to this, it is possible to restrain the simultaneous nozzle drive power, by altering the drive timings of the respective blocks located in the same main scanning direction.

In order to attain the aforementioned object, the present invention is also directed to an image forming apparatus, comprising: a long liquid droplet ejection head in which a plurality of nozzles are arranged; a conveyance device which attracts a recording medium by means of electrostatic attraction and conveys the recording medium in a sub-scanning direction substantially perpendicular to a main scanning direction; and a control device which controls drive timing of the nozzles, wherein, when a solid area comprising at least one of a region of substantially uniform density and a gradation region having a density change is formed on the recording medium, the control device: does drive, at a substantially simultaneous drive timing, a plurality of mutually adjacent nozzles corresponding to a central region that excludes boundary regions comprising edge sections in the main scanning direction of the solid area and vicinity of the edge sections; and does drive the plurality of nozzles corresponding to the boundary regions of the solid area at a drive timing different from a drive timing at which the mutually adjacent nozzles corresponding to the central region are driven.

According to the present invention, the nozzles corresponding to the boundary regions of the solid area are driven at different drive timings to the plurality of adjacent nozzles corresponding to the central region of the solid area. Therefore, the flight liquid droplets from the nozzle corresponding to the boundary regions of the solid area are not affected by forces of electrostatic repulsion, and hence blurring or thickening at the edges in the conveyance direction of the recording medium of the boundary regions of the solid area can be improved.

Moreover, the pluralities of adjacent nozzles corresponding to the central region of the solid area are driven at the substantially same drive timing. Hence, the visibility of stripes or unevenness in the conveyance direction of the recording medium caused by a defective nozzle or a nozzle producing landing position displacement that is intrinsic to the nozzle, is reduced due to the effects of electrostatic repulsion.

Preferably, the control device changes the drive timing of the nozzles corresponding to the boundary regions with respect to each droplet ejection operation.

By adopting the mode in which the drive timings of the nozzles corresponding to the boundary regions of the solid area are changed at each droplet ejection operation, blurring and thickening at the edges thereof in the conveyance direction of the recording medium of the boundary regions of the solid area, can be improved.

In order to attain the aforementioned object, the present invention is also directed to an image forming apparatus, comprising: a long liquid droplet ejection head in which a plurality of nozzles are arranged; a conveyance device which attracts a recording medium by means of electrostatic attraction and conveys the recording medium in a sub-scanning direction substantially perpendicular to a main scanning direction; and a control device which controls drive timing of the nozzles, wherein, when a solid area comprising at least one of a region of substantially uniform density and a gradation region having a density change is formed on the recording medium, the control device: does drive, at a substantially simultaneous drive timing, a plurality of mutually adjacent nozzles corresponding to a central region that excludes boundary regions comprising edge sections in the main scanning direction of the solid area and vicinity of the edge sections; does not drive the nozzles corresponding to the edge sections in the main scanning direction of the solid area; and does drive the nozzles corresponding to the vicinity of the edge sections in the main scanning direction of the solid area at a drive timing substantially simultaneous as a drive timing of the nozzles corresponding to the central region of the solid area, and also at a drive timing different from the drive timing of the nozzles corresponding to the central region of the solid area.

By adopting the mode in which the nozzles corresponding to the vicinity of the edge sections in the main scanning direction of the solid area are driven instead of the nozzles corresponding to the edge sections of the solid area in the main scanning direction, blurring and thickening at the edges thereof in the conveyance direction of the recording medium in the boundary regions of the solid area, can be improved.

In order to attain the aforementioned object, the present invention is also directed to an image forming apparatus, comprising: a long liquid droplet ejection head in which a plurality of nozzles are arranged; a conveyance device which attracts a recording medium by means of electrostatic attraction and conveys the recording medium in a sub-scanning direction substantially perpendicular to a main scanning direction; and a control device which controls drive timing of the plurality of nozzles, wherein the control device selects, from the plurality of nozzles, at least one set comprising one nozzle and a first proximate nozzle which ejects a flight liquid droplet which is affected and deflected by forces of electrostatic repulsion when ejected at a drive timing substantially simultaneous as a drive timing of the one nozzle, controls ejection in such a manner that the drive timings of the one nozzle and the first proximate nozzle are substantially simultaneous, and changes selection patterns of the one nozzle and the first proximate nozzle according to conveyance time of the recording medium.

According to the present invention, by ejecting droplets from the one nozzle and the first proximate nozzle at the substantially same drive timing, the flight liquid droplets are affected by electrostatic repulsion and slight displacement (a swaying phenomenon/a swaying effect) occurs in the landing positions of the flight liquid droplets. Since the swaying effect varies over the paper conveyance time as the selection pattern of the one nozzle and the first proximate nozzle is changed, then the visibility of stripes or unevenness in the paper conveyance direction caused by landing position displacement intrinsic to the nozzle is reduced.

If only the flight liquid droplets ejected from two adjacent nozzles at the substantially same drive timing are affected by forces of electrostatic repulsion and deflected accordingly, then these two nozzles respectively form first proximate nozzles with respect to other nozzles.

Preferably, the control device controls the ejection from the nozzles in such a manner that a drive timing of the nozzles other than the one nozzle and the first proximate nozzle is different from a drive timing of a second proximate nozzle that is arranged closely to the nozzles other than the one nozzle and the first proximate nozzle.

According to this, as well as achieving similar beneficial effects stated above, the flight liquid droplets from the nozzles other than the one nozzle and the first proximate nozzle are not affected by electrostatic repulsion and land at their originally intended landing positions. Therefore, print quality is maintained.

The control device may randomly change the selection patterns of the one nozzle and the first proximate nozzle according to the conveyance time of the recording medium.

The control device may periodically change the selection patterns of the one nozzle and the first proximate nozzle according to the conveyance time of the recording medium.

There are the modes in which selection pattern of the one nozzle and the proximate nozzle is randomly or periodically changed, with the paper conveyance time.

In order to attain the aforementioned object, the present invention is also directed to an image forming apparatus, comprising: a long liquid droplet ejection head in which a plurality of nozzles are arranged; a conveyance device which attracts a recording medium by means of electrostatic attraction and conveys the recording medium in a sub-scanning direction substantially perpendicular to a main scanning direction; and a droplet ejection substitution device which controls ejection from the nozzles, wherein in a case where if at least two first nozzles of the nozzles are driven at a substantially simultaneous drive timing, then liquid droplets ejected from the at least two first nozzles of the nozzles land at droplet landing positions on the recording medium that face second nozzles other than the first nozzles of the nozzles: when dots are to be formed at the droplet landing positions on the recording medium that face the second nozzles, the droplet ejection substitution device causes droplets to be appropriately ejected by the first nozzles so as to form the dots.

According to the present invention, the flight liquid droplets ejected substantially simultaneously from the at least two first nozzles are deflected and land at droplet landing positions on the recording medium which face second nozzles, other than the first nozzles. Hence, at the droplet landing positions on the recording medium which face the second nozzles, the dots by the plurality of the nozzles in the sub-scanning direction are combined. Therefore, even if there is a nozzle producing landing position displacement, it is possible to reduce the visibility of stripes or unevenness caused by a nozzle producing landing position displacement.

Preferably, the image forming apparatus further comprises: a storage device which stores a plurality of droplet ejection patterns for substituting droplet ejection by the first nozzles for droplet ejection by the second nozzles; and a selection device which selects, in accordance with image data, a desired droplet ejection pattern from the plurality of the droplet ejection patterns stored in the storage device, wherein the droplet ejection substitution device substitutes the droplet ejection by the first nozzles for the droplet ejection by the second nozzles according to the droplet ejection pattern selected by the selection device.

According to this, flight liquid droplets ejected substantially simultaneously from the at least two first nozzles are deflected to land at droplet landing positions on the recording medium which face second nozzles, on the basis of a desired droplet ejection pattern selected in accordance with the image data. Therefore, at the droplet landing positions on the recording medium which face the second nozzles, the dots by the plurality of the nozzles are combined. Therefore, even if there is a nozzle producing landing position displacement, it is possible to reduce the visibility of stripes or unevenness caused by the nozzle producing landing position displacement.

Preferably, the selection device randomly selects the droplet ejection pattern according to conveyance time of the recording medium.

According to this, since the droplet ejection pattern is randomly changed with the paper conveyance time, it is possible to reduce further the visibility of stripes or unevenness in the conveyance direction of the recording medium.

According to the present invention, it is possible to reduce the visibility of stripes or unevenness caused by the nozzle producing landing position displacement.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing of one embodiment of an inkjet recording apparatus as an image forming apparatus according to the present invention;

FIG. 2 is a plan view of the principal part of the peripheral area of a print unit in the inkjet recording apparatus shown in FIG. 1;

FIG. 3 is a principal block diagram showing the system composition of the inkjet recording apparatus;

FIG. 4 is a plan view of a print head as viewed from the nozzle surface;

FIG. 5 is a cross-sectional diagram along line 5-5 in FIG. 4;

FIG. 6 is a cross-sectional diagram showing a further example of the structure of a print head;

FIG. 7 is an illustrative diagram showing a droplet ejection control method according to a first embodiment;

FIG. 8 is an illustrative diagram showing an example of a droplet ejection control method according to a second embodiment;

FIG. 9 is an illustrative diagram showing further example of a droplet ejection control method according to a second embodiment;

FIGS. 10A to 10E are illustrative diagrams showing examples of droplet ejection patterns used in a droplet ejection control method according to a third embodiment;

FIG. 11 is an illustrative diagram showing the printing results in a case where the droplet ejection patterns shown in FIGS. 10A to 10E are changed randomly;

FIG. 12 is an illustrative diagram showing the printing results in a case where the droplet ejection patterns shown in FIGS. 10A to 10E are changed periodically;

FIGS. 13A to 13D are illustrative diagrams showing examples of droplet ejection patterns used in a droplet ejection control method according to a fourth embodiment;

FIG. 14 is a flow diagram for the replacement of droplet ejection by a certain nozzle with droplet ejection by a deflected nozzle group;

FIG. 15 is an example of a droplet ejection pattern search table;

FIG. 16 is an example of a nozzle replacement table;

FIG. 17 is an illustrative diagram showing printing results according to a related droplet ejection control method;

FIG. 18 is an illustrative diagram showing printing results according to a related droplet ejection control method;

FIG. 19 is an illustrative diagram showing printing results according to a related droplet ejection control method;

FIG. 20 is an illustrative diagram showing printing results according to a related droplet ejection control method;

FIG. 21 is an illustrative diagram of a case where liquid droplets are ejected simultaneously from two adjacent nozzles; and

FIG. 22 is an illustrative diagram of a case where liquid droplets are ejected simultaneously from three adjacent nozzles.

### DETAILED DESCRIPTION OF THE PREFERRED EMBODIMENTS

General Composition of Inkjet Recording Apparatus

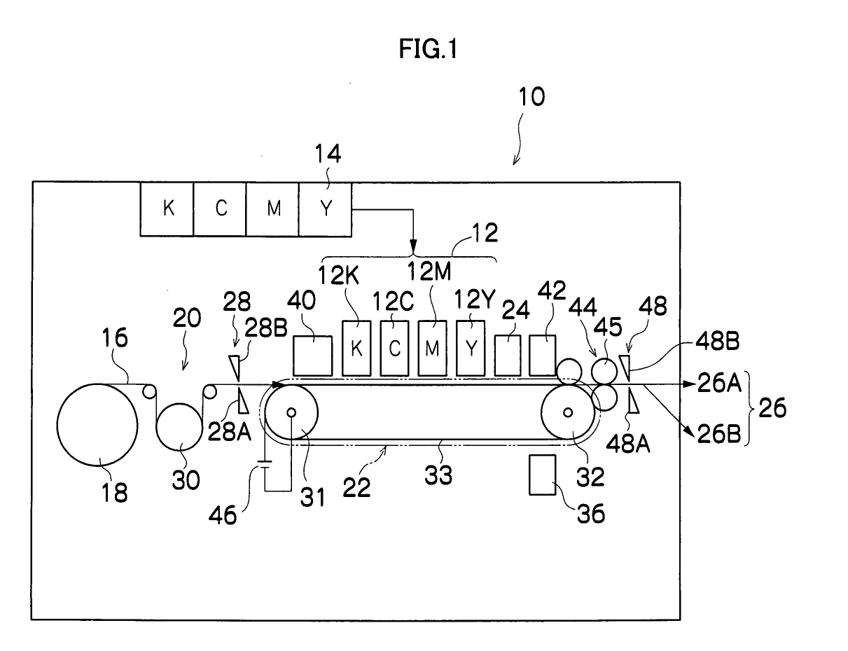

FIG. 1 is a general schematic drawing of an embodiment of an inkjet recording apparatus which forms an image forming apparatus. As shown in FIG. 1, the inkjet recording apparatus 10 comprises: a print unit 12 having a plurality of print heads 12K, 12C, 12M, and 12Y for ink colors of black (K), cyan (C), magenta (M), and yellow (Y), respectively; an ink storing and loading unit 14 for storing inks of K, C, M and Y to be supplied to the print heads 12K, 12C, 12M, and 12Y; a paper supply unit 18 for supplying recording paper 16; a decurling unit 20 for removing curl in the recording paper 16; a suction belt conveyance unit 22 disposed facing the nozzle face (ink-droplet ejection face) of the print unit 12, for conveying the recording paper 16 while keeping the recording paper 16 flat; a print determination unit 24 for reading the printed result produced by the print unit 12; and a paper output unit 26 for outputting image-printed recording paper (printed matter) to the exterior.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which roll paper is used, a cutter 28 is provided as shown in FIG. 1, and the roll paper is cut to a desired size by the cutter 28. The cutter 28 has a stationary blade 28A, of which length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyance path. When cut paper is used, the cutter 28 is not required.

In the case of a configuration in which a plurality of types of recording paper can be used, it is preferable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

The decurled and cut recording paper 16 is delivered to the suction belt conveyance unit 22. The suction belt conveyance unit 22 has a configuration in which an endless electrostatic attraction belt 33 is set around rollers 31 and 32 so that the portion of the endless electrostatic attraction belt 33 facing at least the nozzle face of the printing unit 12 and the sensor face of the print determination unit 24 forms a horizontal plane (flat plane).

The width of the electrostatic attraction belt 33 is larger than the width of the recording paper 16. The electrostatic attraction belt 33 has in-built electrodes (not shown), which are formed so as to make contact with the roller 31. Furthermore, a DC high-voltage generator 46 is connected to the roller 31. When a DC high-voltage is applied to the roller 31 by the DC high-voltage generator 46, the electrostatic attraction belt 33 wound about the roller 31 becomes charged and the recording paper 16 is attracted to and held on the electrostatic attraction belt 33 due to an electrostatic attraction effect.

The electrostatic attraction belt 33 is driven in the clockwise direction in FIG. 1 by the motive force of a motor (not shown) being transmitted to at least one of the rollers 31 and 32, which the electrostatic attraction belt 33 is set around. As a result of that, the recording paper 16 held on the electrostatic attraction belt 33 is conveyed from left to right in FIG. 1.

Since ink adheres to the electrostatic attraction belt 33 when a marginless print job or the like is performed, a belt-cleaning unit 36 is disposed in a predetermined position (a suitable position outside the printing area) on the exterior side of the electrostatic attraction belt 33. Although the details of the configuration of the belt-cleaning unit 36 are not shown in the diagrams, examples thereof include a configuration in which the electrostatic attraction belt 33 is nipped with cleaning rollers such as a brush roller and a water absorbent roller, an air blow configuration in which clean air is blown onto the electrostatic attraction belt 33, and a combination of these. In the case of the configuration in which the electrostatic attraction belt 33 is nipped with the cleaning rollers, it is preferable to make the linear velocity of the cleaning rollers different than that of the electrostatic attraction belt 33 to improve the cleaning effect.

A heating fan 40 is disposed on the upstream side of the printing unit 12 above the conveyance pathway formed by the suction belt conveyance unit 22. The heating fan 40 blows heated air onto the recording paper 16 to heat the recording paper 16 immediately before printing so that the ink deposited on the recording paper 16 can dry more easily.

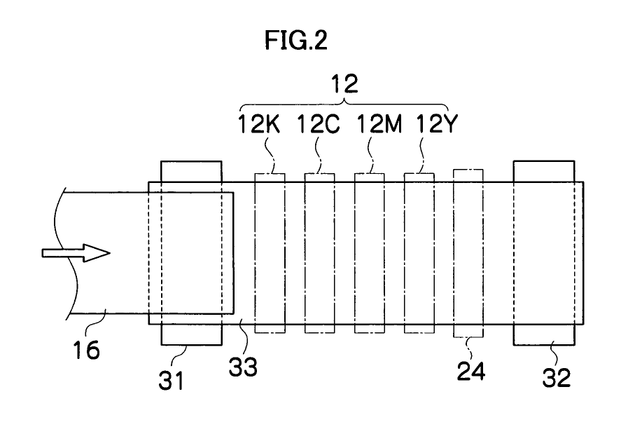

The print unit 12 is a so-called “full line head” in which a line head having a length corresponding to the maximum paper width is arranged in a direction (main scanning direction) that is perpendicular to the paper conveyance direction (sub-scanning direction) (see FIG. 2).

As shown in FIG. 2, each of the print heads 12K, 12C, 12M and 12Y which constitute the print unit 12 comprises a line head in which a plurality of ink ejection ports (nozzles) are arranged through a length exceeding at least one edge of the maximum size recording paper 16 intended for use with the inkjet recording apparatus 10.

The print heads 12K, 12C, 12M, 12Y corresponding to respective ink colors are disposed in the order, black (K), cyan (C), magenta (M) and yellow (Y), from the upstream side (left-hand side in FIG. 1), following the direction of conveyance of the recording paper 16 (the paper conveyance direction). A color print can be formed on the recording paper 16 by conveying the recording paper 16 and ejecting the inks from the print heads 12K, 12C, 12M, and 12Y, respectively, onto the recording paper 16.

The print unit 12, in which the full-line heads covering the entire width of the paper are thus provided for the respective ink colors, can record an image over the entire surface of the recording paper 16 by performing the action of moving the recording paper 16 and the print unit 12 relatively to each other in the paper conveyance direction (sub-scanning direction) just once (in other words, by means of a single sub-scan). Higher-speed printing is thereby made possible and productivity can be improved in comparison with a shuttle type head configuration in which the print head moves reciprocally in a direction (main scanning direction) which is perpendicular to the paper conveyance direction.

Although the configuration with the KCMY four standard colors is described in the present embodiment, combinations of the ink colors and the number of colors are not limited to those. Light inks or dark inks can be added as required. For example, a configuration is possible in which print heads for ejecting light-colored inks such as light cyan and light magenta are added.

As shown in FIG. 1, the ink storing and loading unit 14 has tanks for storing inks of the colors corresponding to the respective print heads 12K, 12C, 12M and 12Y, and each tank is communicated with the respective print head 12K, 12C, 12M, 12Y, via a tube channel (not shown). Moreover, the ink storing and loading unit 14 also comprises a notifying device (display device, alarm generating device, or the like), which generates a notification in which case the remaining amount of ink has become low, and a mechanism for preventing incorrect loading of the wrong colored ink.

The print determination unit 24 has an image sensor (line sensor) for capturing an image of the ink-droplet deposition result of the printing unit 12, and functions as a device to check for ejection defects such as clogs of the nozzles in the printing unit 12 from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the print heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern image printed by the print heads 12K, 12C, 12M, and 12Y for the respective colors, and determines the ejection of each head. The ejection determination includes the presence of the ejection, measurement of the dot size, and the like.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed on the same large sheet of paper, the test print portion is cut and separated by a cutter (second cutter) 48. The cutter 48 is disposed just before the paper output unit 26, and is used for cutting the test print portion from the target print portion when a test print has been performed in the blank portion of the recording medium. The structure of the cutter 48 is the same as the first cutter 28 described above, and has a stationary blade 48A and a round blade 48B.

Although not shown, the paper output unit 26A for the target prints is provided with a sorter for collecting prints according to print orders.

The print heads 12K, 12C, 12M and 12Y provided for the respective ink colors have the same structure, and a reference numeral 50 is hereinafter designated to any of the print heads 12K, 12C, 12M and 12Y.

Description of Control System

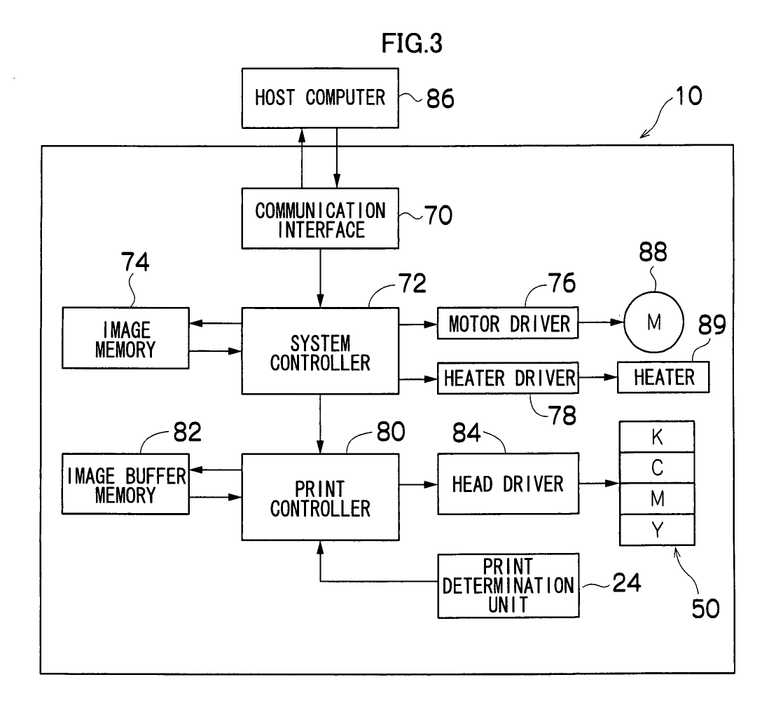

FIG. 3 is a principal block diagram showing the system configuration of the inkjet recording apparatus 10. The inkjet recording apparatus 10 comprises a communication interface 70, a system controller 72, an image memory 74, a motor driver 76, a heater driver 78, a print controller 80, an image buffer memory 82, a head driver 84, and the like.

The communication interface 70 is an interface unit for receiving image data sent from a host computer 86. A serial interface such as USB, IEEE1394, Ethernet, wireless network, and a parallel interface, or a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is a control unit for controlling the various sections, such as the communication interface 70, the image memory 74, the motor driver 76, the heater driver 78, and the like. The system controller 72 is constituted by a central processing unit (CPU), peripheral circuits thereof, and the like. In addition to controlling communications with the host computer 86 and controlling reading and writing from and to the image memory 74, or the like, the system controller 72 also generates a control signal for controlling the motor 88 of the conveyance system and the heater 89.

The motor driver (drive circuit) 76 drives the motor 88 in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print control signal (print data) to the head driver 84. Prescribed signal processing is carried out in the print controller 80, and the ejection amount and the ejection timing of the ink droplets from the respective print heads 50 are controlled via the head driver 84, on the basis of the print data. By this means, desired dot size and dot positions can be achieved. The control of the nozzle drive timings, the storage and selection of droplet ejection patterns, the substitution of ejection droplets, and other characteristic features of the present embodiment are performed by this print controller 80.

The print controller 80 is provided with the image buffer memory 82; and image data, parameters, and other data are temporarily stored in the image buffer memory 82 when image data is processed in the print controller 80. The aspect shown in FIG. 3 is one in which the image buffer memory 82 accompanies the print controller 80; however, the image memory 74 may also serve as the image buffer memory 82. An aspect in which the print controller 80 and the system controller 72 are integrated to form a single processor is also possible.

The head driver 84 drives the heat-generating elements (not shown in FIG. 3 and indicated by reference numeral 58 in FIG. 5) of the print heads 50 of the respective colors, 12K, 12C, 12M, 12Y, on the basis of print data supplied by the print controller 80. A feedback control system for maintaining constant drive conditions for the print heads may be included in the head driver 84.

As shown in FIG. 1, the print determination unit 24 is a block including a line sensor (not shown), which reads in the image printed onto the recording paper 16, performs various signal processing operations, and the like, and determines the print situation (presence/absence of ejection, variation in size of ejected droplet, and the like). The print determination unit 24 supplies these detection results to the print controller 80.

According to requirements, the print controller 80 makes various corrections with respect to the print head 50 on the basis of information obtained from the print determination unit 24.

Structure of Print Head

Next, the structure of the print head 50 will be described.

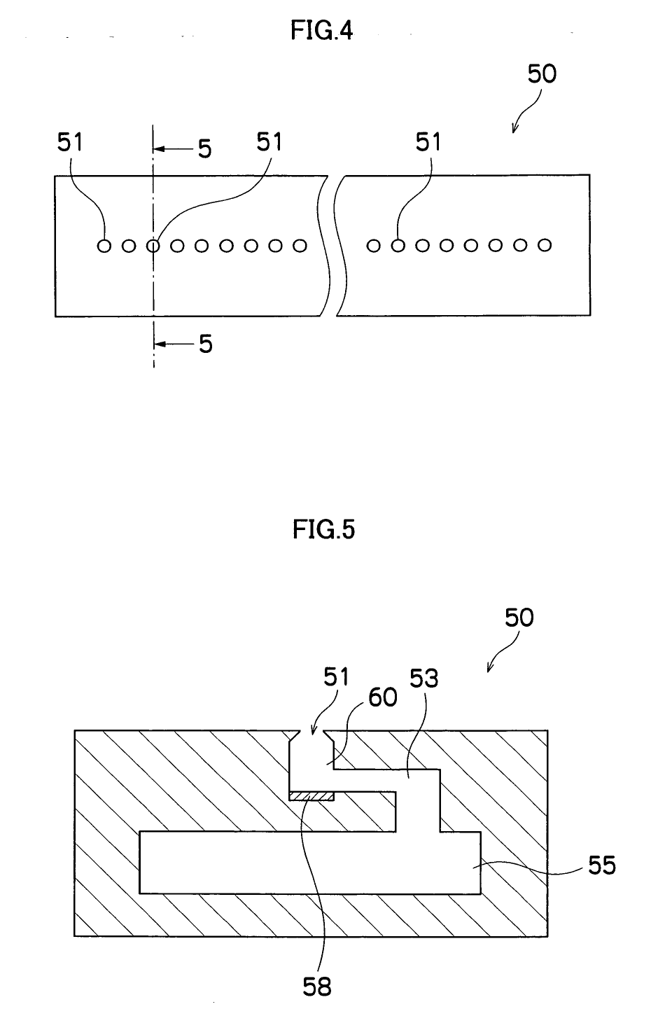

FIG. 4 is a plan view of the print head 50 as viewed from the nozzle surface. As shown in FIG. 4, a plurality of nozzles 51 for ejecting ink droplets are formed in the print head 50 in an alignment in the lengthwise direction of the head. The nozzles are not limited to being formed in one row only, and by adopting a plurality of nozzle rows, it is possible to increase the recording density.

FIG. 5 is a cross-sectional diagram along line 5-5 in FIG. 4. As shown in FIG. 5, a common liquid chamber 55 connected to each nozzle 51 via an ink supply channel 53 is provided in the print head 50. The common liquid chamber 55 is connected to an ink supply tank (not shown), and stores ink for supplying to the respective nozzles 51.

Furthermore, heat generating elements 58 are also provided in the print head 50, in a one-to-one correspondence with respect to the nozzles 51. The heat generating element 58 is composed in such a manner that a nozzle 51 is disposed directly above the heat generating element 58 (in the upward direction in FIG. 5), and the substantially perpendicular direction with respect to the heat generating element 58 coincides with the direction of flight of the liquid droplet from the nozzle 51. The heat generating element 58 is electrically connected to a power supply wire (not shown) provided in the print head 50. When a drive signal corresponding to the image data is supplied to the heat generating element 58, the heat generating element 58 generates heat.

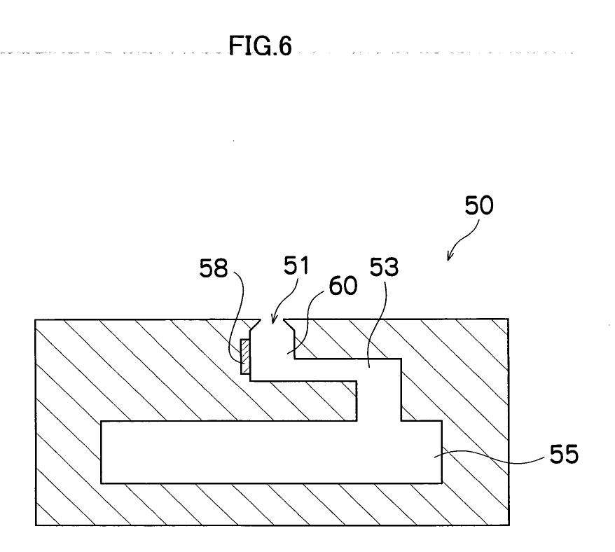

In implementing the present embodiment, the arrangement of the heat generating elements 58 is not limited to that of the example illustrated. For example, it is also possible to adopt a mode in which the direction substantially parallel to the heat generating element 58 is the direction of flight of the liquid droplets from the nozzle 51, as in the further structural example of a print head 50 shown in FIG. 6.

Next, the action of the print head 50 having the composition described above will be explained with reference to FIG. 5.

The ink accumulated in the common liquid chamber 55 is filled into the nozzle flow channel 60, via the ink supply channel 53. When a drive signal corresponding to the image data is supplied to a heat generating element 58 by the head driver 84 (see FIG. 3), this drive signal is passed along the power supply wire (not shown) to the heat generating element 58, which generates heat accordingly. When a gas bubble is produced in the ink due to the thermal energy of the heat generating element 58, a portion of the ink is ejected out of the print head 50 from the nozzle 51, in the form of an ink droplet, due to the pressure created when the gas bubble is produced, and this ink forms a dot on the recording paper 16. By repeating this operation, a prescribed image is formed on the recording paper 16.

In the present embodiment, a thermal jet method is used which produces gas bubbles inside the nozzles by means of heat generating elements 58, and causes ink droplets to be ejected due to the pressure created by these bubbles, but in implementing the present embodiment, the method for ejecting ink is not limited to this. Various other types of method may be adopted: for instance, a piezo method which ejects ink droplets from nozzles by applying a pressure to the ink inside pressure chambers by means of the deformation of actuators as typified by piezoelectric elements.

Droplet Ejection Control Method

Next, a method for controlling droplet ejection in the print head 50 according to the embodiments relating to the present invention will be described.

### First Embodiment

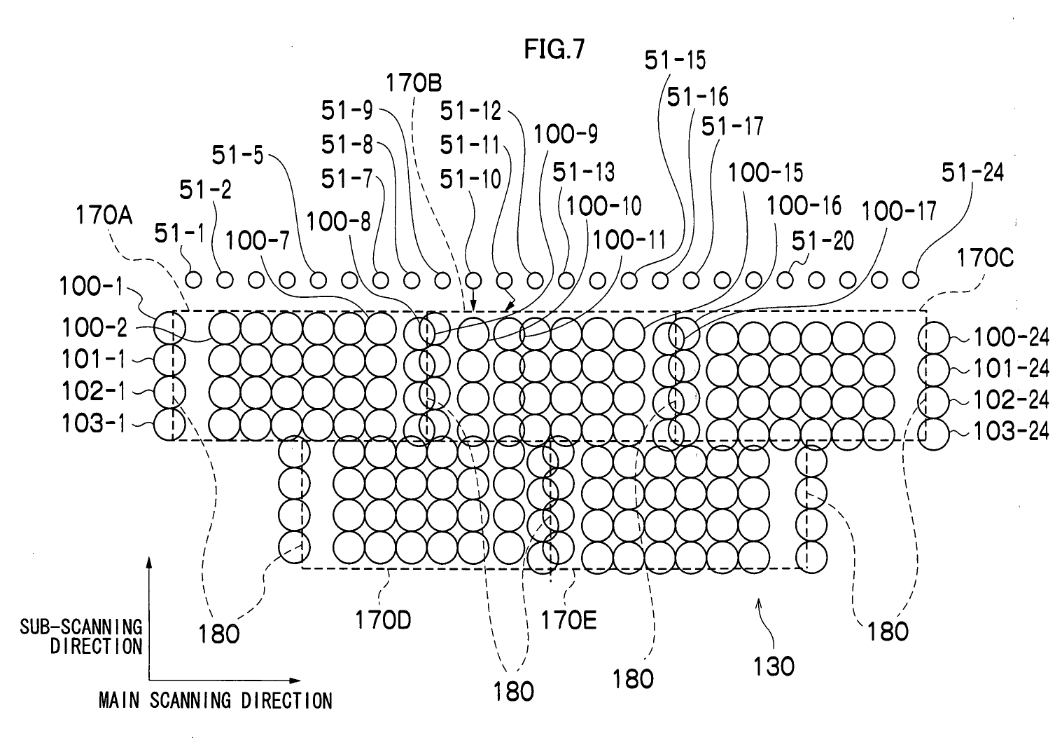

FIG. 7 is an illustrative diagram showing a droplet ejection control method according to a first embodiment of the present invention. The nozzle 51-11 is a nozzle producing landing position displacement, from which the droplet lands in a position deflected toward nozzle 51-12. In order to simplify the description, a case where solid printing is performed by driving 24 nozzles 51-1, . . . , 51-24 will be described. However, the number of nozzles is not limited to this example.

In the present embodiment, a solid area 130 having a deformed T shape is divided into a plurality of blocks 170A, 170B, 170C, 170D and 170E, in the main scanning direction and sub-scanning direction. The plurality of nozzles corresponding to these respective blocks 170A, . . . , 170E is driven substantially simultaneously. In this case, the boundary lines 180 which divide the blocks 170A, . . . , 170E in the main scanning direction are not continuous in the sub-scanning direction between blocks which are mutually adjacent in the sub-scanning direction. For example, the left and right-hand boundary lines of block 170B in FIG. 7 are not continuous in the sub-scanning direction with the left and right-hand boundary lines of blocks 170D and 170E which are adjacent to block 170B in the sub-scanning direction in FIG. 7. The shape of the solid area 130 is not limited to the example shown in the drawing. Furthermore, the solid area is either a region where printing is performed at substantially uniform density, or a gradation region where the density changes. This also applies hereinafter.

The size of the divided blocks in the main scanning direction is decided on the basis of the power required to drive the nozzles simultaneously. Furthermore, the size of the blocks in the sub-scanning direction is decided on the basis of the visibility of stripes or unevenness. Desirably, the size of the blocks in the sub-scanning direction is kept to or below approximately 5 mm.

In FIG. 7, firstly, at the first drive timing, the nozzles 51-1, . . . , 51-8 corresponding to the block 170A are driven substantially simultaneously, and dots 100-1, . . . , 100-8 are formed.

In this case, since the nozzles 51-1 and 51-8 are located at the edges of the group of nozzles which eject droplets substantially simultaneously, the dots 100-1 and 100-8 are formed respectively at positions deflected toward the opposite side with respect to the nozzles 51-2 and 51-7 due to the effects of electrostatic repulsion.

On the other hand, the nozzles 51-2, . . . , 51-7 are not located in the edge sections of the group of nozzles which eject droplets substantially simultaneously. Therefore, the effects of the electrostatic repulsion on the flight liquid droplets cancel each other out and the dots 100-2, . . . 100-7 are formed respectively in their originally intended landing positions in the main scanning direction.

Next, at the second drive timing which is slightly delayed from the first drive timing, the nozzles 51-9, . . . , 51-16 corresponding to block 170B are driven substantially simultaneously. The drive timings of the respective blocks are separated by a time differential sufficient to ensure that there are little or no effects of electrostatic repulsion between flight liquid droplets ejected at adjacent positions in the respective blocks.

Since the nozzles 51-9 and 51-16 are located at the edges of the group of nozzles which eject droplets substantially simultaneously, the dots 100-9 and 100-16 are formed respectively at positions deflected toward the opposite side with respect to the nozzles 51-10 and 51-15 due to the effects of electrostatic repulsion.

On the other hand, the nozzles 51-10, . . . , 51-15 (excluding nozzle 51-11) are not located in the edge sections of the group of nozzles which eject droplets substantially simultaneously. Therefore, the effects of the electrostatic repulsion on the flight liquid droplets cancel each other out and the dots 100-10, . . . . 100-15 (excluding dot 100-11) are formed respectively in their originally intended landing positions in the main scanning direction.

The distance from the flight liquid droplet ejected from the nozzle 51-11 producing landing position displacement to the flight liquid droplet ejected from the adjacent nozzle 51-12 in the direction of landing position displacement is shorter than the distance from the flight liquid droplet ejected from the nozzle 51-11 to the flight liquid droplet from the adjacent nozzle 51-10 on the opposite side to the direction of landing position displacement. Therefore, the force of electrostatic repulsion caused by the flight liquid droplet from the nozzle 51-12 is greater than the force of electrostatic repulsion caused by the flight liquid droplet from the nozzle 51-10. Accordingly, the flight liquid droplet from the nozzle 51-11 producing landing position displacement is deflected and caused to return toward its originally intended landing position in the main scanning direction, thus the dot 100-11 is formed.

Subsequently, at the third drive timing which is slightly delayed from the second drive timing, the nozzles 51-17, . . . , 51-24 corresponding to the block 170C are driven substantially simultaneously, and dots 100-17, . . . , 100-24 are formed, as in the case of the block 170A.

At the fourth to twelfth drive timings, droplet ejection operations as in the case of those in the first to third drive timings are repeated respectively in the nozzles corresponding to the blocks 170A, 170B and 170C. The repetition of these droplet ejection operations is achieved by staggering, within the droplet ejection period in the sub-scanning direction, the phase of the drive timings of the respective blocks 170A, 170B and 170C. In the example shown in FIG. 7, the number of droplets ejected by each of the nozzles 51-1, . . . , 51-24 is four, and hence four dots are formed by each nozzle in the sub-scanning direction. In implementing the present embodiment, the number of droplets ejected to each block is not limited to four.

At the thirteenth drive timing, the nozzles 51-5, . . . , 51-12 corresponding to the block 170D are driven substantially simultaneously, and at the fourteenth drive timing, the nozzles 51-13, . . . , 51-20 corresponding to the block 170E are driven substantially simultaneously. In the block 170D, a drive timing of the same phase as the block 170A is used, and in the block 170E, a drive timing of the same phase as the block 170B is used. In this case, the flight liquid droplets from the nozzles corresponding to the edges of the blocks 170D and 170E are shifted toward the outside of each block due to the effects of electrostatic repulsion, and the flight liquid droplet from the nozzle 51-11 producing landing position displacement is deflected and caused to return toward its originally intended landing position in the main scanning direction, as in the case of the block 170B.

In this way, by driving substantially simultaneously the nozzles corresponding to the respective blocks into which the solid area 130 is divided in the main scanning direction and the sub-scanning direction, it is possible to prevent landing position displacement due to the effects of electrostatic repulsion in the parts apart from the borders which divide the blocks in the main scanning direction.

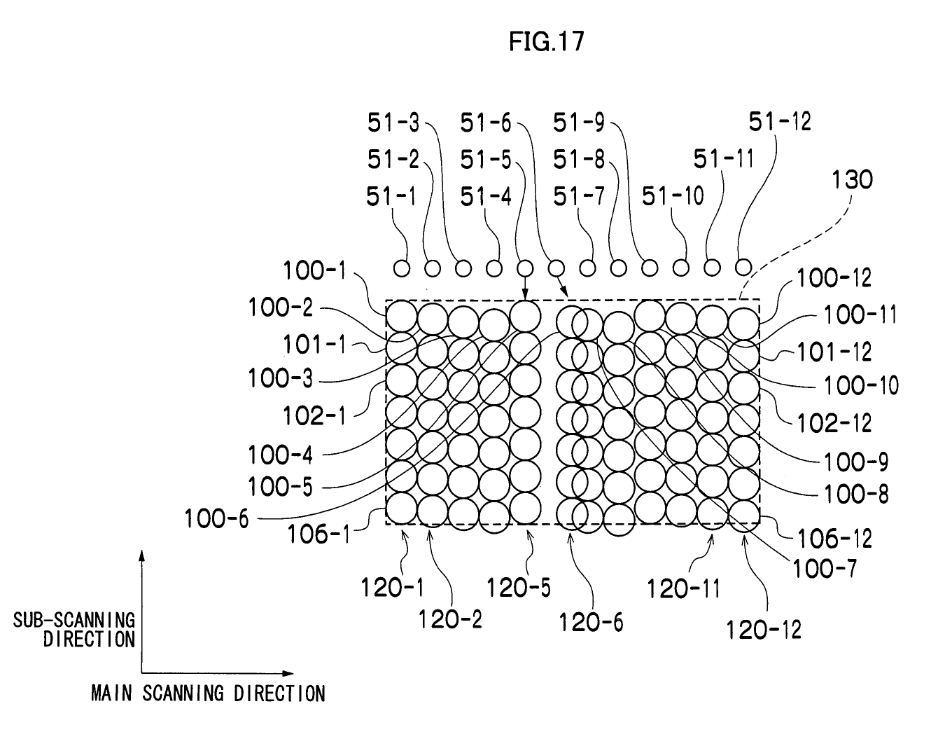

In particular, since the nozzles inside each block are driven substantially simultaneously, the flight liquid droplets from the nozzle 51-11 producing landing position displacement that is intrinsic to the nozzle and is difficult to be identified are deflected and caused to return toward their originally intended landing positions in the main scanning direction, due to the effects of electrostatic repulsion. Therefore, the visibility of stripes or unevenness in the sub-scanning direction is reduced, compared with the case shown in FIG. 17.

Moreover, by altering the drive timing for each block located on the same line in the main scanning direction, it is possible to reduce the number of nozzles which are driven at the almost same driving timing. Hence, the simultaneous drive power for the nozzles can be reduced.

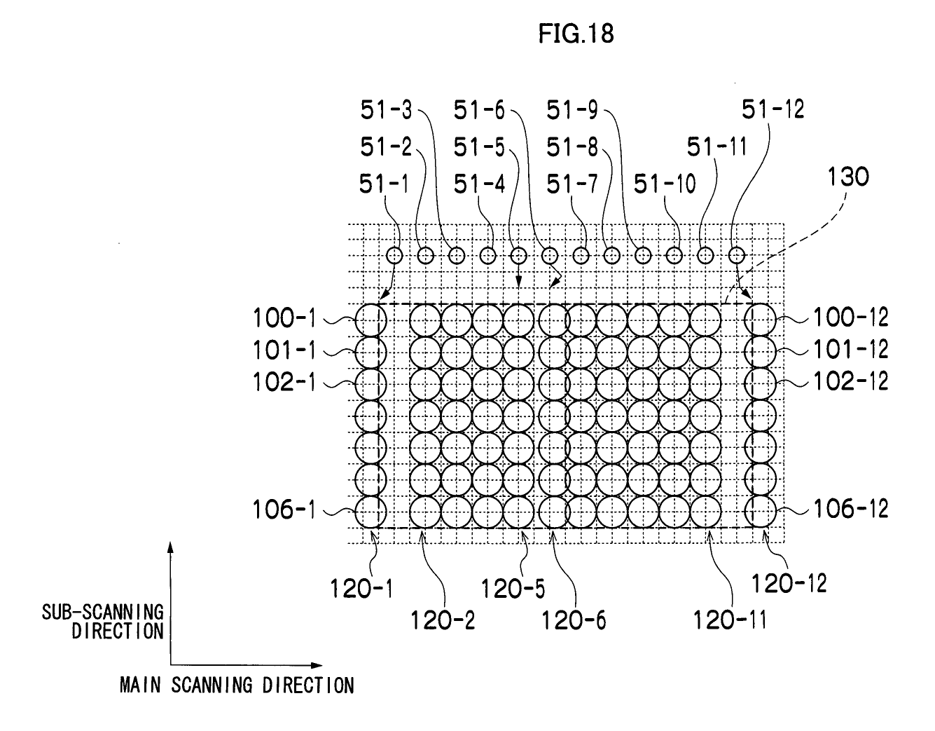

Furthermore, the boundary lines which divide the blocks in the main scanning direction are not continuous in the sub-scanning direction between blocks which are adjacent in the sub-scanning direction. Hence, if any stripes or unevenness occurs in the sub-scanning direction at the boundary regions (edge sections or the vicinity of same) where the blocks are divided in the main scanning direction when the nozzles corresponding to each block are driven substantially simultaneously, this stripes or unevenness is not continuous between blocks in the sub-scanning direction, and hence the visibility of stripes or unevenness in the solid area 130 overall is reduced in comparison with the case shown in FIG. 18.

Furthermore, if printing is performed in a high-quality mode, it is desirable that the conveyance speed of the recording paper 16 be slowed. If the conveyance speed of the recording paper 16 is high and the ejection cycle of each nozzle is short, then, for example, the ejection intervals between the nozzles 51-9, 51-10, 51-11 and 51-12 at the changeover between blocks 170B and 170D, for instance, may be even shorter. Hence, ink refilling may not be sufficient to meet demand, leading to disparities in the volume of the ejected liquid droplets. By slowing the conveyance speed of the recording paper 16, it is possible to lengthen the ejection cycles of the nozzles to a level which does not affect refilling, and therefore, the printing can be performed without the occurrence of disparities in the volume of the ejected liquid droplets.

In implementing the present embodiment, the number of nozzles corresponding to each block is not limited to eight, as shown in the example in FIG. 7. Furthermore, the number of nozzles corresponding to each block may differ between the blocks.

### Second Embodiment

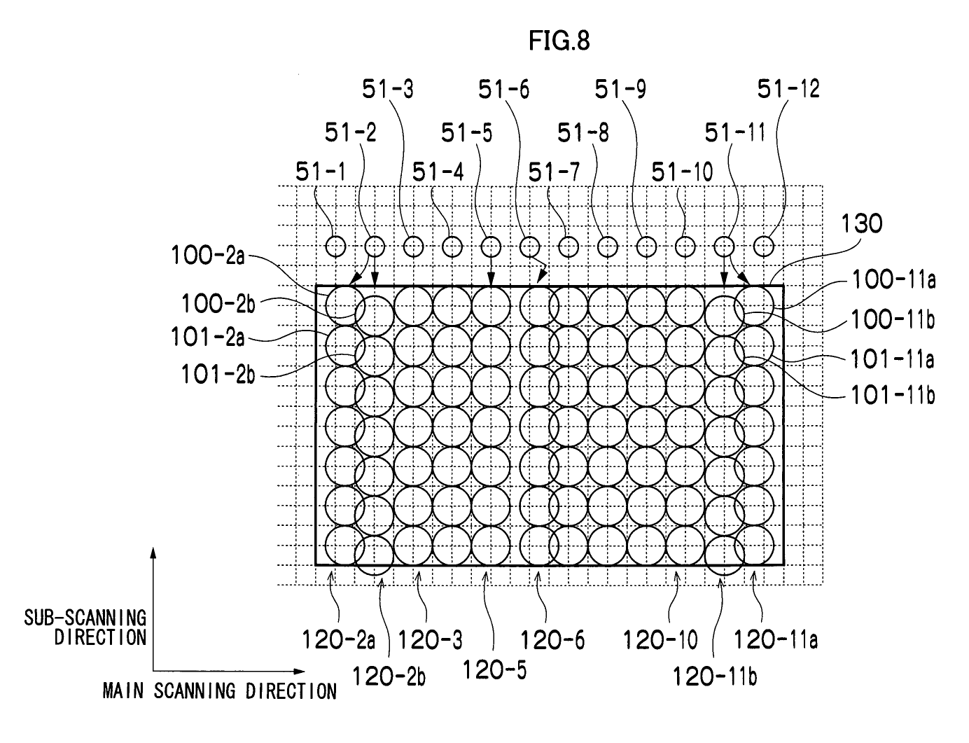

FIG. 8 is an illustrative diagram showing an example, of a droplet ejection control method according to a second embodiment of the present invention, and it shows the printing results in a case where a solid area is printed. In FIG. 8, the nozzle 51-6 is a nozzle producing landing position displacement, from which the droplet lands in a position deflected toward nozzle 51-7.

The nozzles 51-4, . . . , 51-9 corresponding to regions other than the boundary regions (edge regions or vicinity thereof) in the main scanning direction of the solid area 130 eject droplets at the substantially same drive timing. Hereinafter, the drive timings of the nozzles 51-1, 51-2 and 51-3 corresponding to the left-hand side boundary region in the main scanning direction of the solid area 130 is described on the basis of FIG. 8, taking the drive timing of the nozzles 51-4, . . . , 51-9 as a reference. The drive timings of the nozzles 51-10, 51-11 and 51-12 corresponding to the right-hand side boundary region of the solid area 130 in the main scanning direction are similar to those of the nozzles 51-1, 51-2 and 51-3, and hence description thereof is omitted here.

Firstly, at the substantially same timing as the first drive timing of the nozzles 51-4, . . . 51-9, the nozzles 51-2 and 51-3 eject droplets. The nozzle 51-1 ejects a droplet at a timing having an ejection time differential from the first drive timing that is sufficient to prevent the effects of electrostatic repulsion. In the example shown in FIG. 8, the nozzle 51-1 ejects a droplet at a timing which is delayed in phase from the first drive timing by ½ of the (droplet ejection) cycle.

In this case, since the nozzle 51-3 is not located in an edge section of the group of nozzles which eject droplets substantially simultaneously, the effects of the electrostatic repulsion on the flight liquid droplets from the nozzle 51-3 cancel each other out and the dot 100-3 is formed at its originally intended landing position in the main scanning direction.

On the other hand, the nozzle 51-2 is positioned at the edge of a group of nozzles which eject droplets substantially simultaneously, and its drive timing is staggered from that of the adjacent nozzle 51-1. Hence, a dot 100-2 is formed at a position deflected toward the nozzle 51-1 in the main scanning direction due to the effects of electrostatic repulsion. FIG. 8 shows a situation where the dot is deflected by ¾ of the dot pitch in the main scanning direction. Furthermore, since the drive timing of the nozzle 51-1 is staggered with respect to the adjacent nozzle 51-2, it is not affected by forces of electrostatic repulsion and a dot 100-1 is formed at the originally intended landing position in the main scanning direction.

Next, the nozzle 51-3 ejects a droplet at the substantially same timing as the second drive timing of the nozzles 51-4, . . . , 51-9, and the nozzle 51-2 ejects a droplet at a phase delay of ⅙ cycle from the second drive timing. Moreover, nozzle 51-1 ejects a droplet at a timing delayed in phase by 3/6 cycle from the second drive timing.

The nozzle 51-3 is positioned at the edge of a group of nozzles which eject droplets substantially simultaneously, and its drive timing is staggered from that of the adjacent nozzle 51-2. Hence, a dot 101-3 is formed at a position deflected toward the nozzle 51-2 in the main scanning direction due to the effects of electrostatic repulsion.

On the other hand, since the drive timings of the nozzles 51-1 and 51-2 are staggered respectively with respect to the adjacent nozzles, there are no effects due to forces of electrostatic repulsion and dots 101-1 and 101-2 are formed at their originally intended landing positions in the main scanning direction.

Next, the nozzle 51-3 ejects a droplet at a timing that is delayed in phase by ⅙ cycle from the third drive timing of the nozzles 51-4, . . . , 51-9, and the nozzle 51-2 ejects a droplet at a timing delayed in phase by 2/6 cycle from the third drive timing. Moreover, nozzle 51-1 ejects a droplet at a timing delayed in phase by 3/6 cycle from the third drive timing.

In this case, since the nozzle 51-4 is positioned at the edge of a group of nozzles which eject droplets substantially simultaneously, a dot 102-4 is formed at a position deflected toward the nozzle 51-3 in the main scanning direction, due the effects of electrostatic repulsion.

On the other hand, since the drive timings of the nozzles 51-1, 51-2 and 51-3 are staggered respectively with respect to those of the adjacent nozzles, there are no effects of forces of electrostatic repulsion and dots 102-1, 101-2 and 102-3 are formed at the originally intended landing positions in the main scanning direction.

At the fourth drive timing and thereafter, the same droplet ejection operations as those in the first to third drive timings are repeated, sequentially.

By altering, for each of the droplet ejection operations, the drive timings of the nozzles 51-1, 51-2, 51-3, 51-10, 51-11, and 51-12 which correspond to boundary regions of the solid area 110 as stated above, the continuous intervals in the sub-scanning direction at the boundary regions of the solid area 130 in the main scanning direction are reduced. Therefore, the visibility of blurring or thickening of the edges is reduced, compared with the case shown in FIG. 18.

Furthermore, the flight liquid droplets from the nozzle 51-6 producing landing position displacement, which is not situated in an edge section of a group of nozzles which eject droplets substantially simultaneously, are affected by forces of electrostatic repulsion from the flight liquid droplets ejected from the adjacent nozzles 51-5 and 51-7. However, the electrostatic repulsion from the flight liquid droplet ejected from the nozzle 51-7 on the side of the landing position displacement direction is greater than the electrostatic repulsion from the flight liquid droplet ejected from the nozzle 51-5. Hence, the flight liquid droplets from the nozzle 51-6 are caused to return toward the original intended landing position in the main scanning direction and form a dot column 120-6 in such a manner that the distance between the dot column 120-5 and the dot column 120-6 is reduced.

If the nozzles 51-4, . . . , 51-9 corresponding to the regions apart from the boundary regions in the main scanning direction of the solid area 130 eject droplets at the substantially same drive timings in this way, it is possible to reduce the visibility of stripes or unevenness caused by defective nozzles and complicated landing variations which are intrinsic to a nozzle and difficult to be identified in real time.

Furthermore, if printing in a high-quality mode is performed, it is desirable that the conveyance speed of the recording paper 16 (see FIG. 1) be slowed. If the conveyance speed of the recording paper 16 is fast and the ejection cycles of the nozzles are short, then, for example, the ejection interval between the dot 102-2 and the dot 103-2 from nozzle 51-2, and the ejection interval between the dot 102-11 and the dot 103-11 from nozzle 51-11 become even shorter, and hence the ink refilling action becomes difficult to meet demand and disparities in the volume of the ejected ink droplets occur. By slowing the conveyance speed of the recording paper 16, it is possible to lengthen the ejection cycles of the nozzles to a level which does not affect refilling, and therefore, printing can be performed without the occurrence of disparities in the volume of the ejected liquid droplets.

In implementing the present embodiment, the phase difference between the drive timing of the nozzles 51-1, 51-2, 51-3, 51-10, 51-11 and 51-12 which correspond to boundary regions in the main scanning direction of the solid area 130, and the drive timing of the nozzles 51-4, . . . , 51-9 which correspond to a part other than the boundary regions in the main scanning direction of the solid area 130, are not limited to the example shown in FIG. 8. Moreover, the number of nozzles corresponding to the boundary regions of the solid area 130 is not limited to the example shown in FIG. 8.

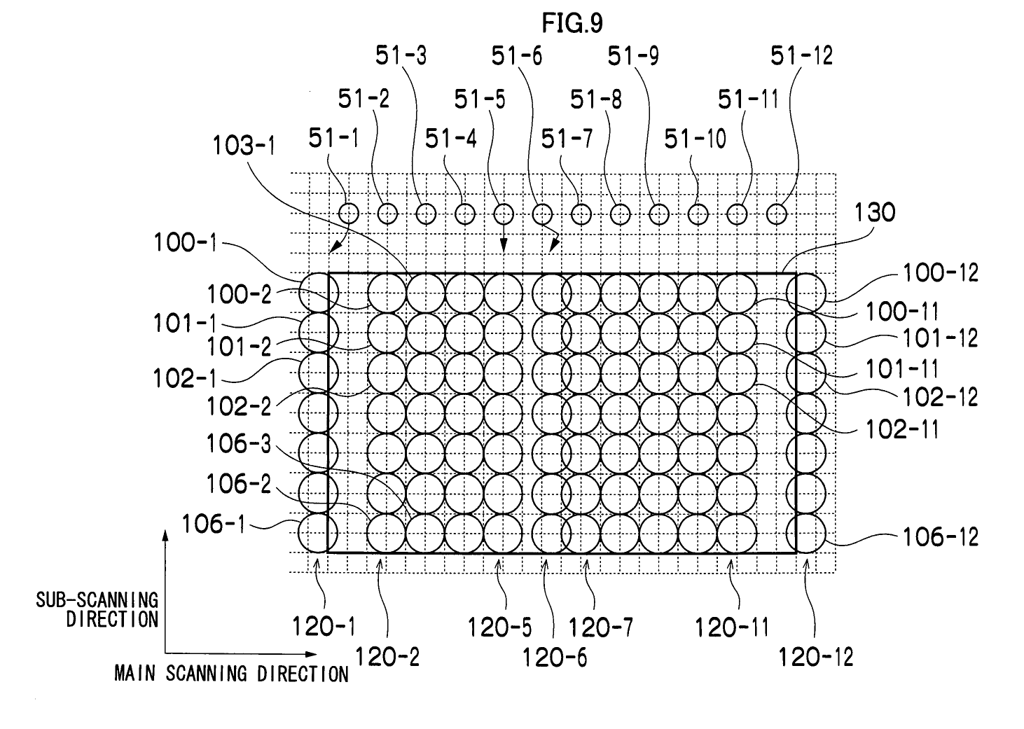

FIG. 9 is an illustrative diagram showing a further example of a droplet ejection control method according to a second embodiment of the present invention, and it shows the printing results in a case where a solid area is printed. In FIG. 9, the nozzles 51-3, . . . , 51-10 corresponding to the boundary regions (edge regions or vicinity thereof) in the main scanning direction of the solid area 130 eject droplets at the substantially same drive timing. Furthermore, the nozzles 51-1, 51-12 corresponding to the edges in the main scanning direction of the solid area 130 do not perform droplet ejection. Hereinafter, the drive timing of the nozzle 51-2 is described with reference to the drive timings of the nozzles 51-3, . . . , 51-10 on the basis of FIG. 9. The drive timing of nozzle 51-11 is similar to that of the nozzle 51-2, and description thereof is omitted here.

The nozzle 51-2 ejects a droplet at the substantially same timing as the first drive timing of the nozzles 51-3, . . . , 51-10, and ejects a droplet at a timing delayed in phase by ¼ cycle from the first drive timing. Consequently, the nozzle 51-2 ejects twice the number of droplets than the nozzles 51-3, . . . , 51-10.

In implementing the present embodiment, the drive timing of the nozzle 51-2 is not limited to that of the present example. The drive timing should be set to a timing which prevents the flight liquid droplet ejected from the nozzle 51-2 from being affected by electrostatic repulsion.

In ejecting a droplet at the substantially same timing as the first drive timing, the nozzle 51-2 is situated in the edge section of a group of nozzles which eject droplets substantially simultaneously. Hence, the dot 100-2a is formed at a position deflected toward the nozzle 51-1 in the main scanning direction due to the effects of electrostatic repulsion. FIG. 9 shows a situation where the dot is deflected by ¾ of the dot pitch in the main scanning direction.

On the other hand, when a droplet is ejected at a timing delayed in phase by ¼ cycle from the first drive timing, the drive timing of the nozzle 51-2 is staggered with respect to the drive timing of the adjacent nozzle 51-3. Hence, the droplet ejected at a timing delayed in phase by ¼ cycle from the first drive timing is not affected by electrostatic repulsion, and a dot 100-2b is formed in the originally intended landing position in the main scanning direction.

At the second and subsequent drive timings of the nozzles 51-3, . . . , 51-10, the nozzle 51-2 ejects droplets as in the case of the first drive timing.

In this way, the nozzles 51-2 and 51-11 which are adjacent to the nozzles 51-1 and 51-12 eject droplets at the substantially same drive timing as the nozzles 51-3, . . . , 51-10, without driving the nozzles 51-1, 51-12 corresponding to the edge sections in the main scanning direction of solid area 130, and the nozzles 51-2 and 51-11 also eject droplets before the nozzles 51-3, . . . , 51-10 perform next droplet ejection. As the result of that, as in the case shown in FIG. 8, the visibility of blurring or thickening at the edges of the boundary regions in the main scanning direction of the solid area 130 is reduced, and the visibility of stripes or unevenness caused by a defective nozzle or a nozzle producing landing position displacement that is intrinsic to the nozzle is also reduced.

When the parts (for example, lines) other than a solid area is printed, it is desirable that the droplet ejection control described above be not implemented and the disperse ejection method described in Japanese Patent Application Publication No. 2001-260342 and Japanese Patent Application Publication No. 2004-42472 be adopted. In this case, it is possible to prevent deterioration of line print quality.

### Third Embodiment

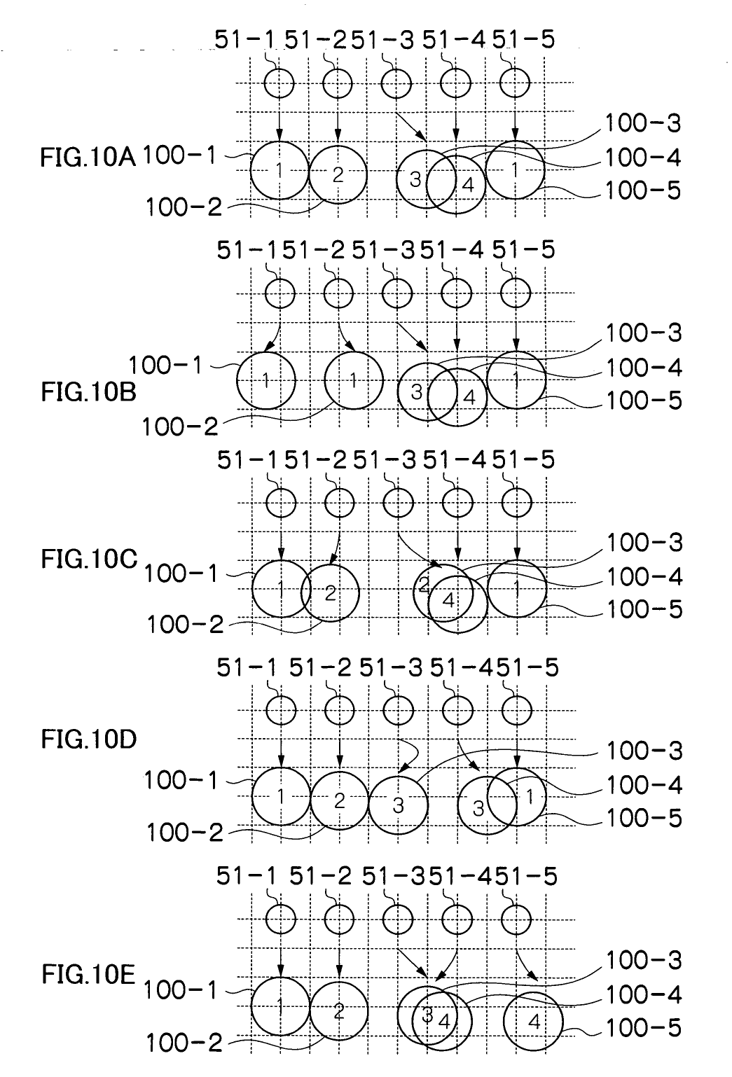

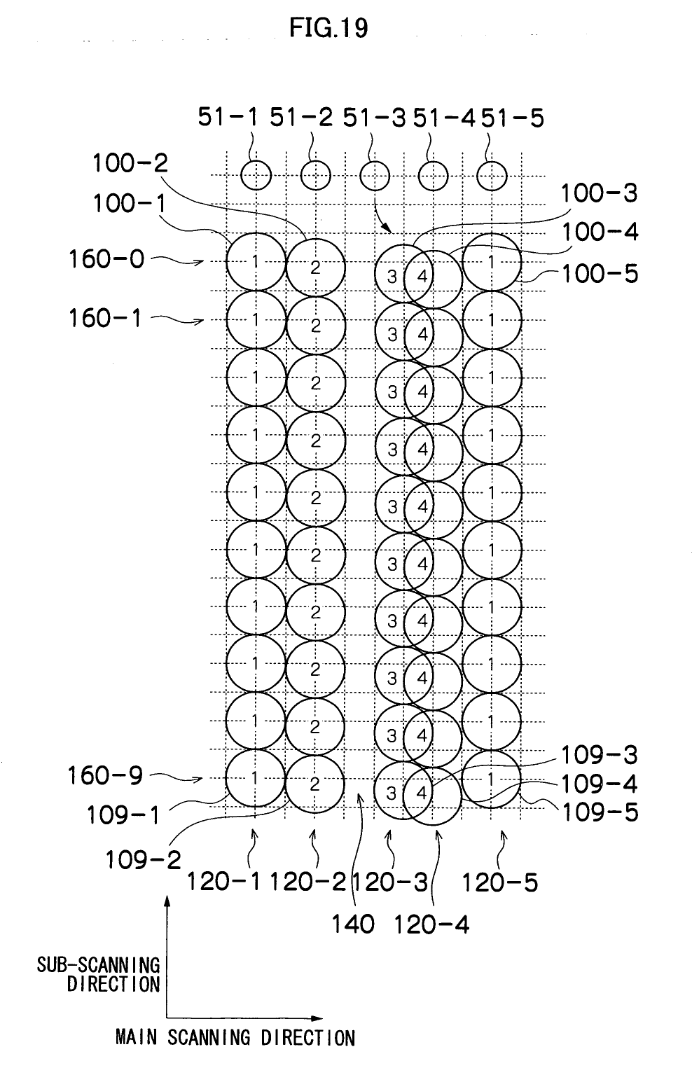

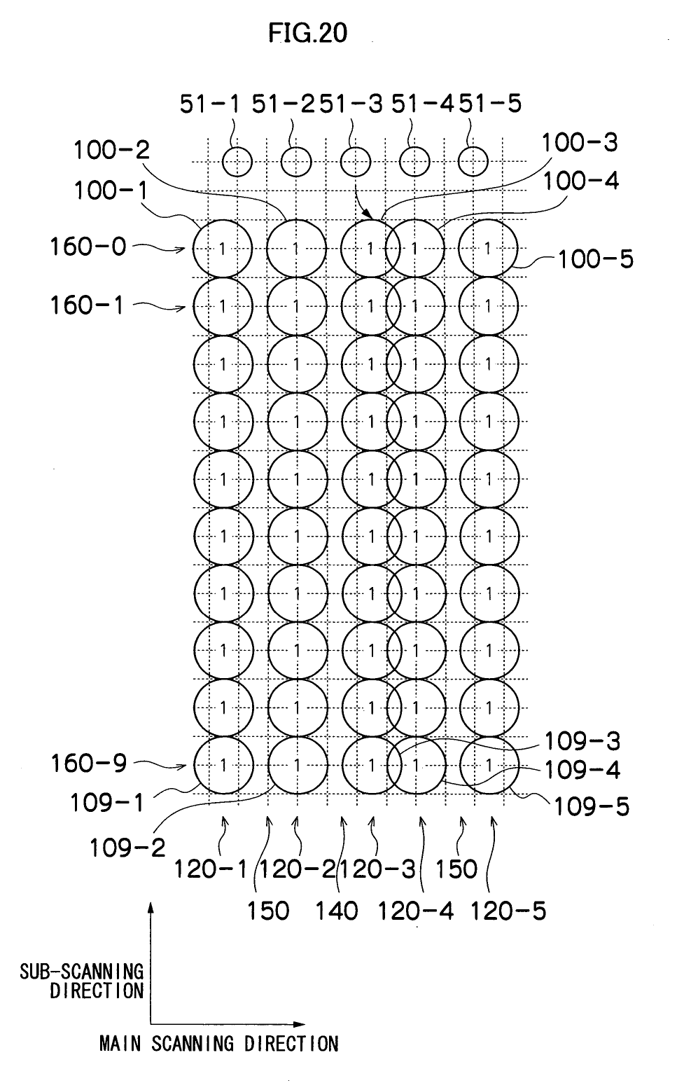

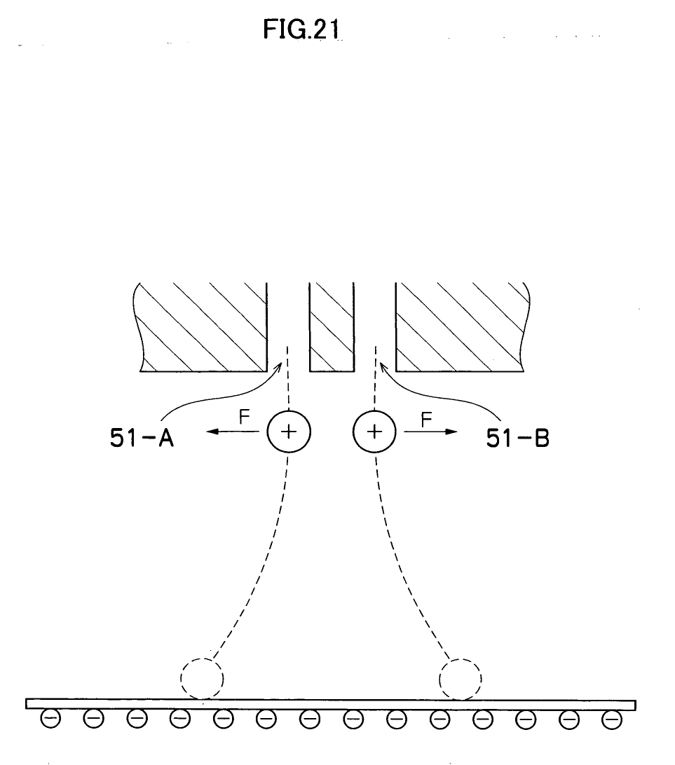

FIGS. 10A to 10E are illustrative diagrams showing droplet ejection patterns used in the droplet ejection control method according to a third embodiment of the present invention. In the related droplet ejection control method shown in FIG. 19 and FIG. 20, the droplet ejection sequence of the nozzles 51-1, . . . , 51-5 corresponding to the respective dot rows 160-0, . . . , 160-9 in the main scanning direction is the same. On the other hand, in the present embodiment, the droplet ejection sequence of the nozzles 51-1, . . . , 51-5 corresponding to the dot rows 160-0, . . . 160-9 in the main scanning direction is changed at random.

In FIGS. 10A to 10E, the nozzle 51-3 is a nozzle producing landing position displacement, from which the droplet is deflected toward nozzle 51-4. Hereinafter, the droplet ejection sequence of the nozzles 51-1, 51-2, 51-3, 51-4 and 51-5 and the dot formation positions in the droplet ejection patterns are described.

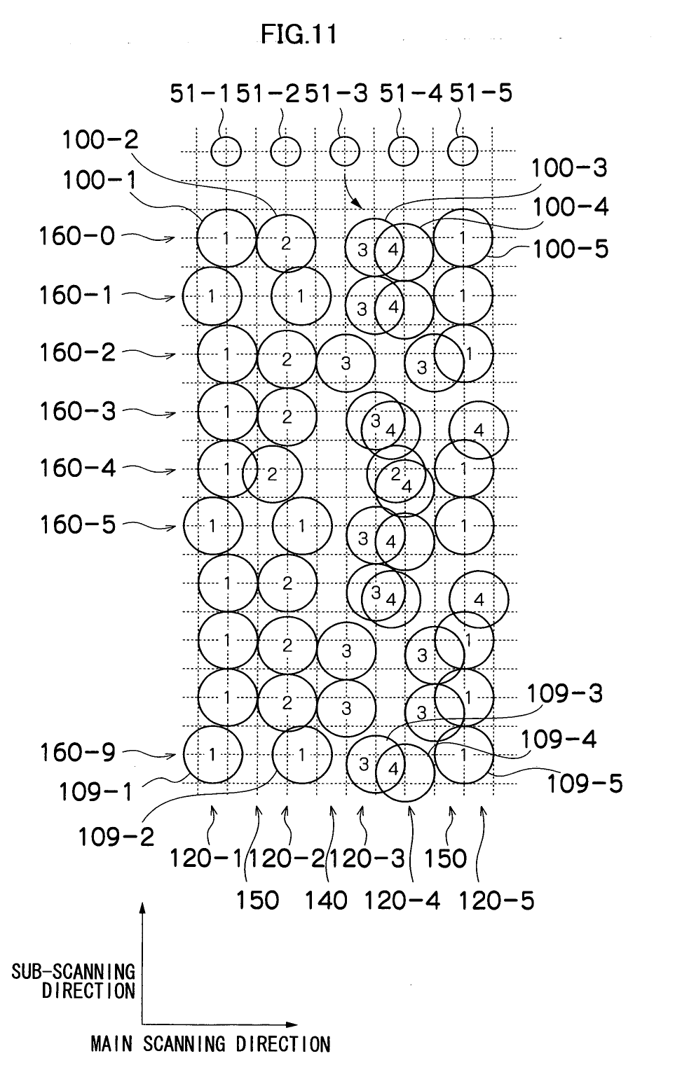

As in the case of FIG. 19 and FIG. 20, in FIGS. 10A to 10E and FIG. 11 mentioned below, the flight liquid droplets ejected at different drive timings are not affected by forces of electrostatic repulsion. Furthermore, of the flight liquid droplets ejected as the same drive timing, droplets that are ejected from adjacent nozzles are affected by electrostatic repulsion, and droplets that are ejected from nozzles other than adjacent nozzles are not affected by electrostatic repulsion.

FIG. 10A is an illustrative diagram showing a first droplet ejection pattern. In FIG. 10A, the non-adjacent nozzles 51-1 and 51-5 eject droplets at the first drive timing, and nozzle 51-2 ejects a droplet at the second drive timing which is slightly delayed from the first drive timing. Subsequently, nozzle 51-3 ejects a droplet at a third drive timing which is slightly delayed from the second drive timing, and nozzle 51-4 ejects a droplet at a fourth drive timing which is slightly delayed from the third drive timing.

Since the flight liquid droplets from the nozzles 51-1 and 51-5 which eject droplets at the first drive timing are not adjacent to each other, the flight liquid droplets from these nozzles are not affected by electrostatic repulsion. Therefore, dots 100-1 and 100-5 are formed at the originally intended landing positions in the main scanning direction (in other words, positions directly below the nozzles 51-1 and 51-5 in FIG. 10A).

Furthermore, the flight liquid droplets from the nozzles 51-2, 51-3 and 51-4 are not affected by forces of electrostatic repulsion, since they have different drive timings from the adjacent nozzles. In this case, since the nozzle 51-3 is a nozzle producing landing position displacement, the flight liquid droplets from this nozzle are deflected toward the nozzle 51-4 located in the direction of the landing position displacement. Consequently, dots 100-2 and 100-4 are formed respectively by nozzles 51-2 and 51-4 in their originally intended landing positions in the main scanning direction (namely, positions directly below the nozzles 51-2 and 51-4 in FIG. 10A), and a dot 100-3 is formed in a position which is displaced toward the nozzle 51-4 from the originally intended landing position in the main scanning direction (namely, a position directly below the nozzle 51-3 in FIG. 10A) by the nozzle 51-3 producing landing position displacement.

FIG. 10B is an illustrative diagram showing a second droplet ejection pattern. In this diagram, in contrast to the first droplet ejection pattern shown in FIG. 10A, nozzle 51-2 also ejects a droplet, in addition to the nozzles 51-1 and 51-5, at the first drive timing. At the second drive timing, no droplets are ejected. At the third and fourth drive timings, the nozzles 51-3 and 51-4 eject droplets respectively, as in the case of the first drive timing.

In the example shown in FIG. 10B, the flight liquid droplets are affected by forces of electrostatic repulsion when adjacent nozzles eject droplets substantially simultaneously. Therefore, of the flight liquid droplets from the nozzles 51-1, 51-2, and 51-5 which eject droplets at the first drive timing, the flight liquid droplets from the adjacent nozzles 51-1 and 51-2 are deflected so that they move away from each other, forming dots 100-1 and 100-2. The nozzle 51-5 is not adjacent to the nozzles 51-1 and 51-2, and has different drive timing to the adjacent nozzle 51-4. Thus, the flight liquid droplets from the nozzle 51-5 are not affected by electrostatic repulsion, and a dot 100-5 is formed at the originally intended landing position in the main scanning direction (namely, a position directly below the nozzle 51-5 in FIG. 10B).

On the other hand, since the nozzles 51-3 and 51-4 have different drive timings from their respective adjacent nozzles, the flight liquid droplets from the nozzles 51-3 and 51-4 are not affected by forces of electrostatic repulsion. Consequently, as in the case of the first droplet ejection pattern, a dot 100-3 is formed at a position deflected toward the nozzle 51-4 from the originally intended landing position in the main scanning direction (namely, a position directly below the nozzle 51-3 in FIG. 10B), and a dot 100-4 is formed at the originally intended landing position in the main scanning direction (namely, a position directly below the nozzle 51-4 in FIG. 10B).

FIG. 10C is an illustrative diagram showing a third droplet ejection pattern. In FIG. 10A, in contrast to the first droplet ejection pattern shown in FIG. 10A, nozzles 51-2 and 51-3 eject droplets at the second drive timing, and droplets are not ejected at the third drive timing. At the first and fourth drive timings, the nozzles 51-1, 51-4 and 51-5 eject droplets respectively, as in the case of the first droplet ejection pattern.

Since the nozzles 51-1 and 51-5 which eject droplets at the first drive timing are not adjacent and their drive timing differs respectively from that of the adjacent nozzles, the flight liquid droplets from the nozzles 51-1 and 51-5 are not affected by forces of electrostatic repulsion and dots 100-1 and 100-5 are formed in their originally intended landing positions in the main scanning direction (namely, positions directly below the nozzles 51-1 and 51-5 in FIG. 10C). Furthermore, as in the case of the first droplet ejection pattern, a dot 100-4 is formed by nozzle 51-4 in its originally intended landing position in the main scanning direction (namely, a position directly below the nozzle 51-4 in FIG. 10C).

On the other hand, the flight liquid droplets ejected from the nozzles 51-2 and 51-3 at the second drive timing are affected by forces of electrostatic repulsion and are deflected so as to separate from each other, thereby dots 100-2 and 100-3 are formed. In this case, since the nozzle 51-3 is a nozzle producing landing position displacement which deflects the droplets toward the nozzle 51-4, the dot 100-3 is formed at a position which is deflected greatly toward the dot 100-4, in comparison with the first droplet ejection pattern and the second droplet ejection pattern.

FIG. 10D is an illustrative diagram showing a fourth droplet ejection pattern. In FIG. 10D, in contrast to the first droplet ejection pattern shown in FIG. 10A, the nozzles 51-3 and 51-4 eject droplets at the third drive timing, and droplets are not ejected at the fourth drive timing. At the first and second drive timings, the nozzles 51-1, 51-2 and 51-5 eject droplets respectively, as in the case of the second droplet ejection pattern.

As in the case of the first droplet ejection pattern, the nozzles 51-1, 51-2 and 51-5 which eject droplets at the first and second drive timings form dots 100-1, 100-2 and 100-5 at their originally intended landing positions in the main scanning direction (namely, positions directly below the nozzles 51-1, 51-2 and 51-5 in FIG. 10D).

On the other hand, of the flight liquid droplet from the nozzles 51-3 and 51-4 which eject droplets at the third drive timing, the flight liquid droplet from the nozzle 51-3 producing landing position displacement is deflected toward the nozzle 51-4. However, the flight liquid droplet from the nozzle 51-3 is caused to return toward the nozzle 51-2 because it is affected by a force of electrostatic repulsion from the flight liquid droplet from nozzle 51-4. In the example shown in FIG. 10D, a dot 100-3 is formed at the originally intended landing position in the main scanning direction. Furthermore, since the flight liquid droplet ejected from the nozzle 51-4 is affected by a force of electrostatic repulsion from the flight liquid droplet ejected from the nozzle 51-3, the flight liquid droplet from the nozzle 51-4 forms a dot 100-4 at a position deflected toward the nozzle 51-5.

FIG. 10E is an illustrative diagram showing a fifth droplet ejection pattern. In FIG. 10E, in contrast to the first droplet ejection pattern shown in FIG. 10A, the nozzle 51-1 ejects a droplet at the first drive timing, and the nozzles 51-4 and 51-5 eject droplets at the fourth drive timing. At the second and third drive timings, the nozzles 51-2 and 51-3 eject droplets, as in the case of the first droplet ejection pattern.

The nozzles 51-1, 51-2 and 51-3 which eject droplets at the first, second and third drive timings have different drive timings to their respective adjacent nozzles. Hence, none of the flight liquid droplets from these nozzles 51-1, 51-2 and 51-3 are affected by electrostatic repulsion. In this case, since the nozzle 51-3 is a nozzle producing landing position displacement, the flight liquid droplets from this nozzle are deflected toward the nozzle 51-4, which is in the direction of the landing position displacement. Consequently, dots 100-1 and 100-2 are formed respectively by nozzles 51-1 and 51-2 in their originally intended landing positions in the main scanning direction (namely, positions directly below the nozzles 51-1 and 51-2 in FIG. 10E), and a dot 100-3 is formed in a position which is deflected toward the nozzle 51-4 from the originally intended landing position in the main scanning direction (namely, a position directly below the nozzle 51-3 in FIG. 10E) by the nozzle 51-3 producing landing position displacement.

On the other hand, since the nozzles 51-4 and 51-5 which eject droplets at the fourth drive timing are mutually adjacent, the flight liquid droplets from the nozzles 51-4 and 51-5 are affected by forces of electrostatic repulsion and are deflected so as to separate from each other, thereby dots 100-4 and 100-5 are formed.

FIG. 11 is an illustrative diagram showing the result of printing in a case where the droplet ejection patterns shown in FIGS. 10A to 10E are changed randomly.

In FIG. 11, the dot rows 160-0, . . . , 160-9 in the main scanning direction are formed by means of the nozzles 51-1, . . . , 51-5 ejecting droplets according to the droplet ejection pattern selected at random from the first to fifth droplet ejection patterns shown in FIGS. 10A to 10E.

For example, the dot rows 160-0, 160-1, 160-2, 160-3 and 160-4 in the main scanning direction are formed respectively by means of the first, second, fourth, fifth and third droplet ejection patterns. In other words, the dot row 160-0 is formed by the first droplet ejection patterns, the dot row 160-1 is formed by the second droplet ejection patterns, the dot row 160-2 is formed by the fourth droplet ejection patterns, the dot row 160-3 is formed by the fifth droplet ejection patterns, and the dot row 160-4 is formed by the third droplet ejection patterns.

FIGS. 10A to 10E and FIG. 11 show examples of droplet ejection patterns where the number of nozzles is five, but the invention is not limited to this.

In this way, in the present embodiment, by changing the droplet ejection sequence of the nozzles 51-1, . . . , 51-5 randomly, the droplet ejection pattern in which at least two adjacent nozzles eject droplets at the substantially same drive timing is selected on the basis of a probability, as in the second, third, fourth and fifth droplet ejection pattern (see FIGS. 10B to 10E). Since the flight liquid droplets from adjacent nozzles which eject droplets substantially simultaneously are affected each other by electrostatic repulsion, there is a slight displacement (swaying phenomenon) in the landing positions of the flight liquid droplets. The droplet ejection sequences of the nozzles 51-1, . . . , 51-5 are changed randomly during the paper conveyance time, in other words, the droplet ejection sequence of the nozzles 51-1, . . . , 51-5 changes randomly in the paper conveyance direction (sub-scanning direction), the swaying phenomenon changes in the sub-scanning direction, and the visibility of the stripes or unevenness 140 in the sub-scanning direction caused by the nozzle 51-3 producing landing position displacement intrinsic to the nozzle is reduced.

In particular, in the present embodiment, it is desirable that at least two adjacent nozzles eject droplets at the substantially same drive timing as in the second, third, fourth and fifth droplet ejection patterns (see FIGS. 10B to 10E), and the droplet ejection sequence of the nozzles 51-1, . . . , 51-5 be changed at random in such a manner that the other nozzles apart from the at least two adjacent nozzles eject droplets at different timings from the nozzles adjacent to these other nozzles.

Furthermore, in the print head 50, it is desirable that the drive timing of each nozzle be controlled in such a manner that the total number of nozzles performing droplet ejection substantially simultaneously is approximately uniform. In this case, it is possible to standardize the power consumed for driving the nozzles of the print head 50.

In order to simplify the description, an example is given in which flight liquid droplets are affected by forces of electrostatic repulsion when adjacent nozzles eject droplets substantially simultaneously. However, the implementation of the present embodiment according to the present invention is not limited to this. For example, if a nozzle which is more distant from a certain nozzle than the adjacent nozzle is a proximate nozzle which ejects a flight liquid droplet that will be affected by a force of electrostatic repulsion when a droplet is ejected substantially simultaneously from the certain nozzle, then the droplet ejection sequence of the nozzles may be changed randomly in such a manner that the certain nozzle and the proximate nozzle eject droplets substantially simultaneously.

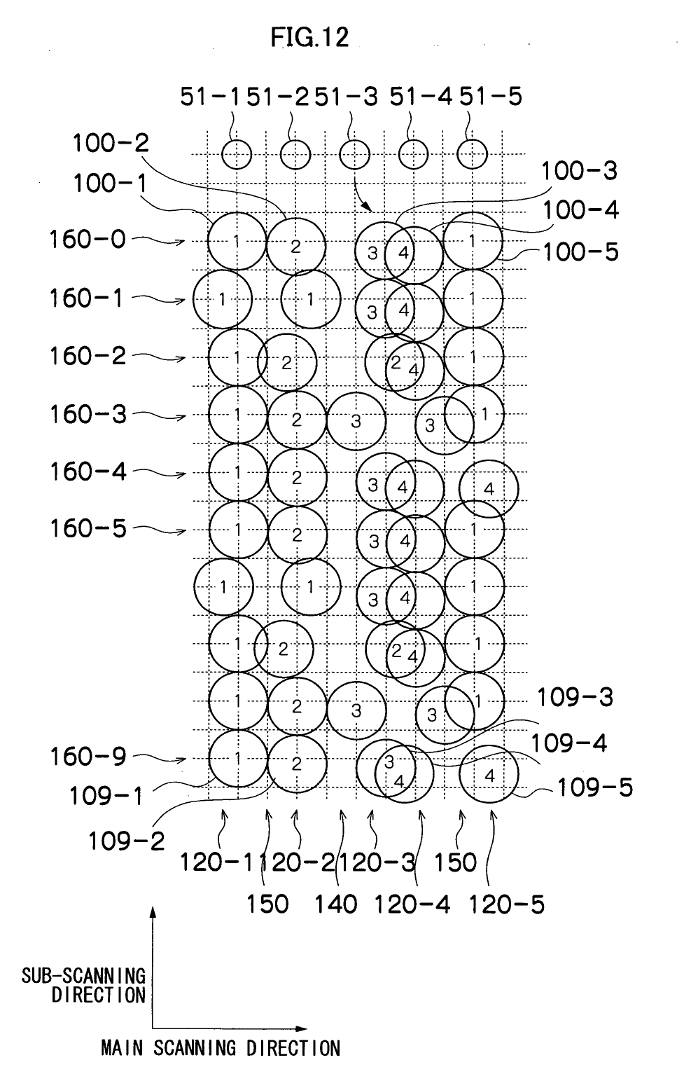

FIG. 12 is an illustrative diagram showing the results of printing in a case where the droplet ejection pattern shown in FIGS. 10A to 10E are changed periodically. The droplet ejection sequence of the nozzles 51-1, . . . , 51-5 corresponding to the dot rows 160-0, . . . , 160-9 in the main scanning direction is changed periodically among the first to fifth droplet ejection patterns shown in FIGS. 10A to 10E.

In FIG. 12, the nozzles 51-1, . . . , 51-5 eject droplets on the basis of the first droplet ejection pattern shown in FIG. 10A, thus forming the dot row 160-0 in the main scanning direction. More specifically, the nozzles 51-1 and 51-5 eject droplets at the first drive timing, and the nozzle 51-2 ejects a droplet at the second drive timing. Subsequently, the nozzle 51-3 ejects a droplet at the third drive timing and the nozzle 51-4 ejects a droplet at the fourth drive timing, whereby the dots 100-1, . . . , 100-5 constituting the dot row 160-0 in the main scanning direction are formed. The positions at which the dots 100-1, . . . , 100-5 are formed are similar to those in FIG. 10A, and description thereof is omitted here.

Subsequently, when the nozzles 51-1, . . . , 51-5 respectively eject droplets in accordance with the second, third, fourth and fifth droplet ejection patterns in FIGS. 10B to 10E, then respective dot rows 160-1, 160-2, 160-3 and 160-4 are formed successively in the main scanning direction. Thereafter, the first to fifth droplet ejection patterns are repeated and the dot rows 160-5, . . . , 160-9 in the main scanning direction are formed.

In this way, in the present embodiment, periodic selective driving is carried out whereby the droplet ejection sequence of the nozzles 51-1, . . . , 51-5 is changed periodically on the basis of the paper conveyance time. In particular, by periodically changing the droplet ejection patterns, in such a manner that adjacent nozzles eject droplets at the substantially same drive timing and nozzles other than the adjacent nozzles which eject droplets at the substantially same timing have a different drive timing from the adjacent nozzles, as in the second, third, fourth and fifth droplet ejection patterns (see FIGS. 10B to 10E), then the swaying phenomenon described above changes in the sub-scanning direction. Hence, the visibility of stripes or unevenness 140 in the sub-scanning direction caused by a nozzle 51-3 producing landing position displacement intrinsic to the nozzle is reduced.

In the present embodiment, the five nozzles, nozzle 51-1, 51-2, 51-3, 51-4 and 51-5 are described as one unit, but this unit is not limited to five nozzles. Furthermore, the nozzles other than these nozzles 51-1, 51-2, 51-3, 51-4 and 51-5 also perform droplet ejection in a similar manner to nozzles 51-1, 51-2, 51-3, 51-4 and 51-5.

Moreover, compared to the print results achieved by the related technology shown in FIG. 20, there is reduced visibility of the stripes or unevenness 150 in the sub-scanning direction at either edge in the main scanning direction of particular regions.

A detailed description has been given of a case where there is a nozzle producing landing position displacement intrinsic to the nozzle. In a case where there is a defective nozzle such as an nozzle failing to eject liquid or a nozzle which ejects a smaller volume of liquid droplet than the intended volume, then the flight liquid droplets from the nozzles adjacent to the defective nozzle may be deflected, with a certain probability, with respect to the originally intended landing position of the flight liquid droplets. Therefore, the present invention is also valuable for correcting defective nozzles in such a case.

### Fourth Embodiment

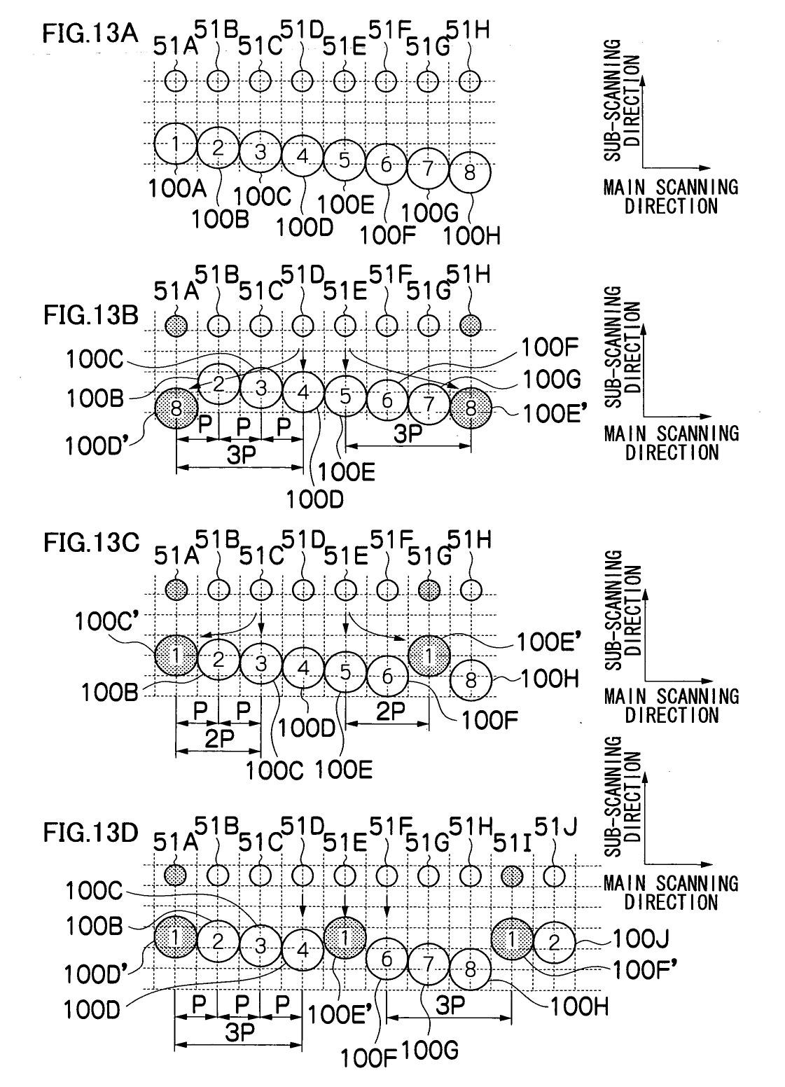

FIGS. 13A to 13D are illustrative diagrams showing droplet ejection patterns used in the droplet ejection control method according to a fourth embodiment of the present invention. FIG. 13A shows a normal droplet ejection pattern. Furthermore, FIGS. 13B, 13C and 13D respectively show first, second and third droplet ejection patterns.

The normal droplet ejection pattern shown in FIG. 13A is a droplet ejection pattern set in an initial state before switching to a deflected nozzle group, which is described hereinafter. In the normal droplet ejection pattern, the nozzles 51A, 51B, 51C, 51D, 51E, 51F, 51G and 51H eject droplets successively, and dots 100A, 100B, 100C, 100D, 100E, 100F, 100G and 100H are formed successively in the main scanning direction. The numerals marked inside the dots 100A, . . . 100H indicate the droplet ejection sequences of the corresponding nozzles 51A, . . . , 51H. For example, the numeral 1 marked inside dot 100A indicates that the droplet ejection sequence of the nozzle 51A corresponding to dot 100A is first in the sequence, and the numeral 8 marked inside dot 100H indicates that the droplet ejection sequence of the nozzle 51H corresponding to dot 100H is eighth in the sequence.

In the present embodiment, normally, the drive timings of the nozzles 51A, . . . , 51H are set in such a manner that the flight liquid droplet from a certain nozzle is not affected by forces of electrostatic repulsion from the flight liquid droplets from other nozzles.

Consequently, since the flight liquid droplets from the nozzles 51A, . . . , 51H are not affected by forces of electrostatic repulsion, the dots 100A, 100B, 100C, 100D, 100E, 100F, 100G and 100H are formed respectively at their originally intended droplet landing position in the main scanning direction (namely, positions directly below the nozzles 51A, . . . , 51H in FIG. 13A).

Furthermore, the dots 10A, . . . , 100H are formed respectively at staggered positions in the sub-scanning direction (paper conveyance direction), in accordance with the differences between the drive timings of the nozzles 51A, . . . , 51H. In FIG. 13A, the displacement in the sub-scanning direction is depicted in an enlarged manner in order to describe the differences between the drive timings of the nozzles 51A, . . . , 51H. However, the actual displacement in the sub-scanning direction is sufficiently small compared to the size of the dots, and hence the dots substantially appear to be positioned in one line in the main scanning direction. This applies similarly to FIGS. 13B to D described hereinafter.

The first droplet ejection pattern shown in FIG. 13B is common to the normal droplet ejection pattern shown in FIG. 13A in that nozzles 51B, . . . , 51G perform droplet ejection respectively at the second to seventh drive timings. However, the pattern shown in FIG. 13B is different from the pattern shown in FIG. 13A in that the substantially simultaneous droplet ejection by nozzles 51D and 51E is substituted for the droplet ejection of the nozzles 51A and 51H.

In the present embodiment, the pitch between nozzles and the distance from the nozzle surface to the print surface, and the like, are adjusted in such a manner that the distance of deflection of the flight liquid droplets affected by electrostatic repulsion is three times the dot pitch P in the main scanning direction if droplets are ejected substantially simultaneously by nozzle 51D and the adjacent nozzle 51E.

Consequently, if the nozzles 51D and 51E eject droplets substantially simultaneously at the eighth drive timing which is different from the drive timing of the other nozzles, then flight liquid droplets from these nozzles are deflected, and dots 100D′ and 100E′ are formed in the originally intended droplet landing positions in the main scanning direction concerning the liquid droplets ejected from the nozzles 51A and 51H (in other words, positions directly below the nozzles 51A and 51H in FIG. 13B).

A nozzle group comprising at least two nozzles which eject droplets substantially simultaneously in such a manner that the flight liquid droplets from these nozzles are deflected by the effects of electrostatic repulsion, is called a “deflected nozzle group”.

In the first droplet ejection pattern, the deflected nozzle group includes the nozzles 51D and 51E.

The second droplet ejection pattern shown in FIG. 13C is common to the normal droplet ejection pattern shown in FIG. 13A in that nozzles 51B, . . . , 51F and 51H perform droplet ejection respectively at the second to sixth and the eighth drive timings. However, the second droplet ejection pattern is different from the pattern shown in FIG. 13A in that the droplet ejection by a deflected nozzle group comprising nozzles 51C and 51E is substituted for the droplet ejection of the nozzles 51A and 51G.

In the present embodiment, the pitch between nozzles and the distance from the nozzle surface to the print surface, and the like, are adjusted in such a manner that, the distance of deflection of the flight liquid droplets affected by electrostatic repulsion is twice the dot pitch P in the main scanning direction if droplets are ejected substantially simultaneously by nozzle 51C and the nozzle 51E which is positioned two nozzles away from nozzle 51C.

Consequently, if the nozzles 51C and 51E eject droplets substantially simultaneously at the first drive timing which is different from the drive timing of the other nozzles, then the flight liquid droplets from these nozzles 51C and 51E are deflected and dots 100C′ and 100E′ are formed in the originally intended droplet landing positions in the main scanning direction concerning the liquid droplets from the nozzles 51A and 51G (in other words, positions directly below the nozzles 51A and 51G in FIG. 13C).

In the third droplet ejection pattern shown in FIG. 13D, the droplet ejection by a deflected nozzle group comprising nozzles 51D, 51E and 51F is substituted for the droplet ejection by nozzles 51A, 51E and 51I.

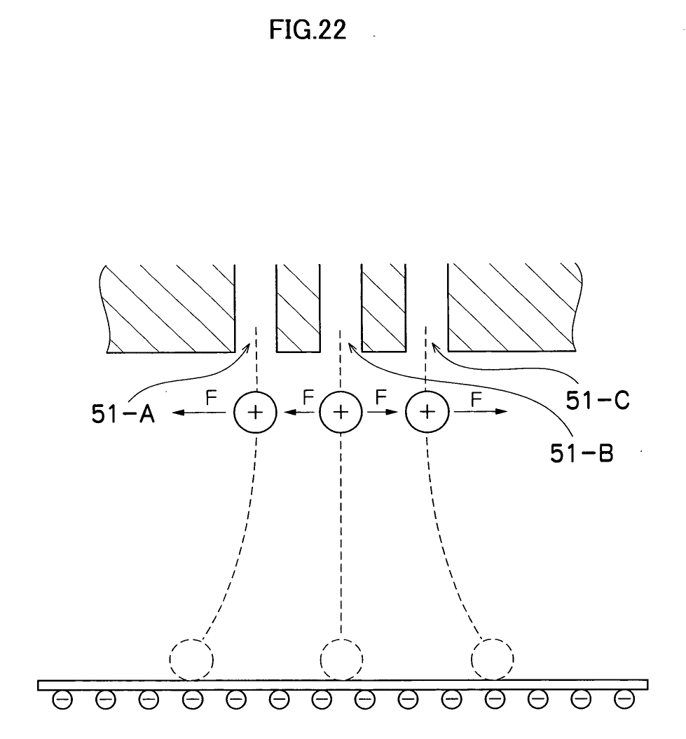

In the present embodiment, as described previously, a composition is adopted whereby the deflection distance of the flight liquid droplets from the two adjacent nozzles is three times the dot pitch P in the main scanning direction. Furthermore, if three adjacent nozzles eject droplets substantially simultaneously, then as described in FIG. 22, the effect of the forces of electrostatic repulsion on the flight liquid droplet ejected from the central nozzle will cancel each other out.

Consequently, if the deflected nozzle group comprising nozzles 51D, 51E and 51F performs droplet ejection substantially simultaneously at the first drive timing, then as shown in FIG. 13D, the effect of the forces of electrostatic repulsion acting on the flight liquid droplet from the nozzle 51E in the central position cancel each other out. Therefore, a dot 100E′ is formed at the originally intended landing position in the main scanning direction (namely, a position directly below the nozzle 51E in FIG. 13D). Furthermore, the flight liquid droplets from the nozzles 51D and 51F positioned on either side of the nozzle 51E are deflected, and respectively form dots 100D′ and 100F′ directly below the nozzles 51A and 51I.

The nozzle 51B and nozzle 51J, which is positioned 9 nozzles away from nozzle 51B, perform droplet ejection substantially simultaneously at the second drive timing. The nozzle 51B and nozzle 51J are adapted so that the flight liquid droplets from the nozzle 51B and nozzle 51J will not be affected by electrostatic repulsion. Therefore, dots 100B and 100J are formed respectively at their originally intended landing positions in the main scanning direction (namely, positions directly below the nozzles 51B and 51J in FIG. 13D).

The droplet ejection from nozzles 51B, 51C, 51G and 51H is similar to those shown in FIGS. 13A to 13C, and description thereof is omitted here.

If a deflected nozzle group ejects droplets substantially simultaneously in this manner, the flight liquid droplets ejected from the deflected nozzle group are affected by forces of electrostatic repulsion and are deflected, and thereby the dots are formed at the original droplet landing positions in the main scanning direction of the nozzles to be replaced, then it is possible to replace appropriately the droplet ejection by the nozzles to be replaced with the droplet ejection from the deflected nozzle group.

In particular, even if there is a nozzle producing landing position displacement, it is possible to reduce the visibility of stripes or unevenness in the sub-scanning direction caused by the nozzle producing landing position displacement because the droplet ejection by the nozzle producing landing position displacement can be replaced appropriately by droplet ejection from the deflected nozzle group.

The replacement of droplet ejection by the nozzle to be replaced with the droplet ejection from the deflected nozzle group is not limited to a case where all of the nozzles eject droplets, as shown in FIGS. 13A to 13D, and may also be applied to a case where droplets are ejected by at least the nozzle to be replaced. For example, in FIG. 13B, if the nozzles 51B and 51C are not to eject droplets and the droplet ejection is performed by the nozzles 51A and 51H to be replaced, then it is possible to replace the droplet ejection by the nozzles 51B and 51C with the droplet ejection by the deflected nozzle group comprising nozzles 51D and 51E.

Furthermore, the droplet ejection pattern is not limited to the first to third droplet ejection patterns shown in FIGS. 13B to 13D, and it is possible to compose any desired droplet ejection pattern in accordance with the deflection distance of the liquid droplets ejected from the deflected nozzle group which eject droplets substantially simultaneously.

Furthermore, although the droplet ejection patterns are indicated for eight nozzles in FIGS. 13A to 13C and for ten nozzles in FIG. 13D in order to simplify the description, the implementation of the present embodiment is not limited to this.

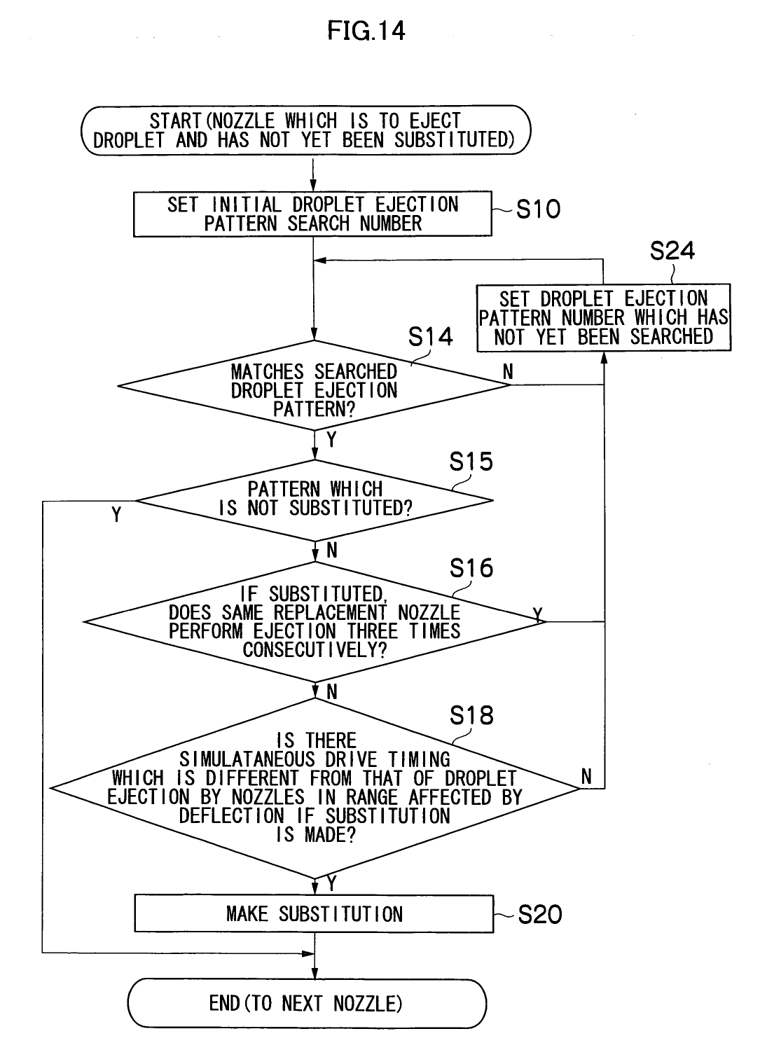

FIG. 14 is a flow diagram for the replacement of droplet ejection by a certain nozzle with droplet ejection by the deflected nozzle group. Hereinafter, a method for selecting a substitution candidate nozzle which has not been replaced by the deflected nozzle group and replacing the droplet ejection from the substitution candidate nozzle with the droplet ejection from the deflected nozzle group when a row of dots in the main scanning direction is formed in accordance with image data, is described on the basis of FIG. 14.

Firstly, at S10, a desired droplet ejection pattern to be firstly searched is selected according to a droplet ejection pattern search table. The droplet ejection pattern search table comprises a plurality of droplet ejection patterns. The droplet ejection patterns are determined on the basis of the nozzle pitch, droplet ejection interval, liquid droplet flight distance, and the like.

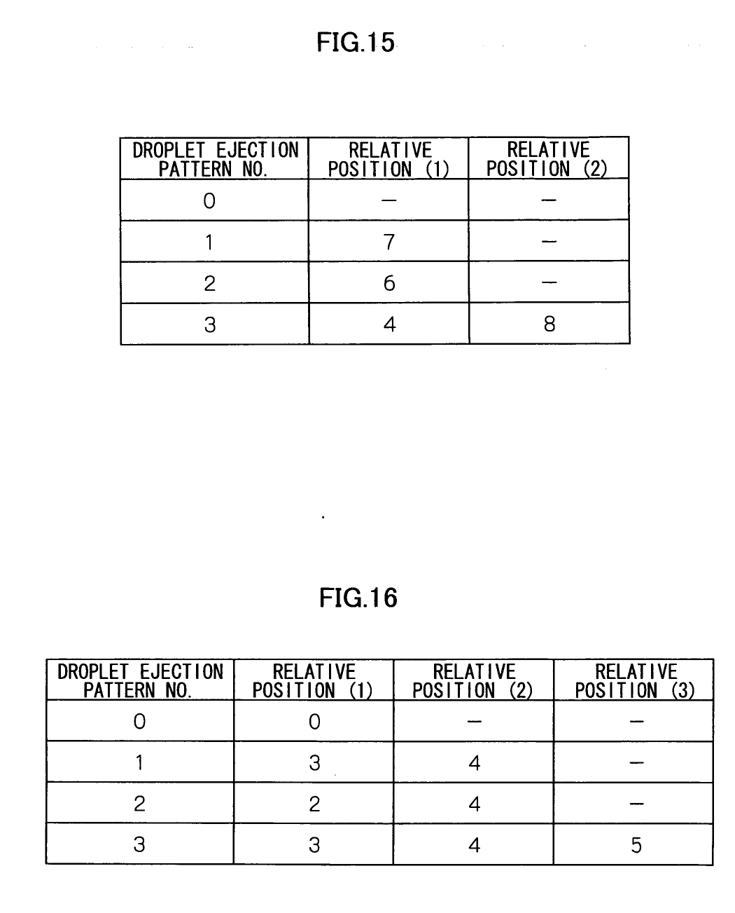

FIG. 15 shows an example of the droplet ejection pattern search table. FIG. 15 corresponds to the droplet ejection patterns shown in FIGS. 13A to 13D, and indicates the relative positions between one of the nozzles (hereinafter referred to as “self-nozzle”) and the nozzle(s) that forms a dot at the substantially same time as a dot that is originally formed by the self-nozzle.

If the droplet ejection pattern number is 0, this corresponds to the normal droplet ejection pattern shown in FIG. 13A. In this case, the relative position is left blank because the nozzle is not replaced with the deflected nozzle group.

If the droplet ejection pattern number is 1, then this corresponds to the first droplet ejection pattern shown in FIG. 13B. In other words, this is a droplet ejection pattern in which there is dot-creation that is originally performed by the self-nozzle in question and dot-creation that is originally performed by a nozzle positioned 7 nozzles away from the self-nozzle. Similarly, the droplet ejection pattern having a droplet ejection pattern number of 2 corresponds to the second droplet ejection pattern shown in FIG. 13C, and in this droplet ejection pattern, there is dot-creation that is originally performed by the self-nozzle in question and dot-creation that is originally performed by a nozzle positioned 6 nozzles away from the self-nozzle.

When the droplet ejection pattern number is 3, then this corresponds to the third droplet ejection pattern shown in FIG. 13D, and in this droplet ejection pattern, there is dot-creation that is originally performed by the self-nozzle in question, dot-creation that is originally performed by a nozzle positioned 4 nozzles away from the self-nozzle, and dot-creation that is originally performed by a nozzle positioned 8 nozzles away from the self-nozzle.

At S14, it is determined whether the dot-creation, on the basis of the image data, by the substitution candidate nozzles and the other nozzles matches the droplet ejection pattern selected at S110 (or S24 described hereinafter) or not.

For example, if the droplet ejection pattern number 1 in FIG. 15 is selected when dots are created, on the basis of the image data, by the substitution candidate nozzle 51A and by nozzle 51H which is positioned 7 nozzles away from nozzle 51A, then this will match the droplet ejection pattern selected on the basis of the droplet ejection pattern search table.

On the other hand, if the droplet ejection pattern number 2 in FIG. 15 is selected when dots are created by only the substitution candidate nozzles 51A and 51H, then this will not match the droplet ejection pattern selected from the droplet ejection pattern search table.

If the dot-creation, on the basis of the image data, by the substitution candidate nozzle and the other nozzles matches the droplet ejection pattern selected at S10 (or S24 described below), then the procedure advances to S15, and if it does not match the searched droplet ejection pattern, then the procedure advances to S24.

Here, a replacement nozzle table used in replacing a substitution candidate nozzle with a deflected nozzle group, will be described. FIG. 16 shows an example of the replacement nozzle table. FIG. 16 corresponds to the droplet ejection patterns shown in FIGS. 13A to 13D, and indicates the respective relative positions of the deflected nozzle group from the self-nozzle in question.

If the droplet ejection pattern number is 0, then this corresponds to the normal droplet ejection pattern shown in FIG. 13A. In this case, the nozzle is not replaced with the deflected nozzle group, and therefore the relative position of the deflected nozzle group is left blank.

If the droplet ejection pattern number is 1, then this corresponds to the first droplet ejection pattern shown in FIG. 13B, and indicates a case where there is dot-creation that is originally performed by the self-nozzle in question and dot-creation that is originally performed by a nozzle positioned 7 nozzles away from the self-nozzle (see FIG. 15). In this case, as shown in FIG. 16, the droplet ejections from the self-nozzle and from the a nozzle positioned 7 nozzles away from the self-nozzle are replaced with droplet ejection by the deflected nozzle group comprising a nozzle positioned three nozzles away from the self-nozzle in question and a nozzle positioned four nozzles away from the self-nozzle.

Similarly, If the droplet ejection pattern is 2, the droplet ejections from the self-nozzle in question and from the nozzle positioned six nozzles away from the self-nozzle (see FIG. 15) are replaced with droplet ejection by the deflected nozzle group comprising a nozzle positioned two nozzles away from the self-nozzle in question and a nozzle positioned four nozzles away from the self-nozzle.

If the droplet ejection pattern is 3, then the droplet ejection from the self-nozzle in question, the droplet ejection from a nozzle positioned four nozzles away from the self-nozzle, and the droplet ejection from a nozzle positioned eight nozzles away from the self-nozzle, are replaced with droplet ejection by the deflected nozzle group comprising nozzles positioned respectively three nozzles away, four nozzles away, and five nozzles away, from the self-nozzle in question.

In this way, using the substitution nozzle table shown in FIG. 16, the substitution candidate nozzles are replaced with droplet ejection by the deflected nozzle group.

The reason the droplet ejection pattern number 0, at which no replacement of nozzles is implemented, is added to the droplet ejection pattern search table (see FIG. 15) and the replacement nozzle table (see FIG. 16) is that the replacement of nozzles is not conducted at a certain probability. In this way, it is possible to prevent the droplet ejections from being performed by replacement nozzles only.

In FIG. 14, at S15, it is determined whether a droplet ejection pattern which does not implement any replacement of droplet ejections by the nozzles has been set or not. If a droplet ejection pattern which does not implement any replacement of droplet ejections by the nozzles has been set, then the procedure ends without any replacement of the droplet ejections by the nozzles.

At S16, it is determined whether droplet ejection by the substitution candidate nozzle continues for three times consecutively in the same nozzle in the previously identified sub-scanning direction or not. This is because, if the droplet ejection from the same nozzle in the sub-scanning direction is continued, then any fluctuation in the droplet landing position or the ejection droplet volume from that nozzle will have a significant impact, and is liable to be visible as stripes or unevenness. If the same nozzle is to perform ejection three times consecutively, then the procedure advances to S24, and if it is not to perform ejection three times consecutively, then the procedure advances to S18.

At S18, if the droplet ejection by the substitution candidate nozzle and the other nozzles is replaced with droplet ejection by the deflected nozzle group, then it is determined whether there is a drive timing different from that of the nozzles other than the deflected nozzle group which would create electrostatic repulsion effects if the droplets were ejected from the nozzles substantially simultaneously with the deflected nozzle group or not. If there is such drive timing, then that drive timing is selected and the procedure advances to S20, and if there is no such drive timing, then the procedure advances to S24.

At S20, by using the replacement nozzle table shown in FIG. 16, the droplet ejection from the substitution candidate nozzle and the other nozzles is replaced with droplet ejection by the deflected nozzle group corresponding to the droplet ejection pattern number selected at S10 (or S24). The drive timing of the substituted deflected nozzle group is the drive timing selected at S118. After that, the processing with respect to the replacement candidate nozzles has terminated, and if the adjacent nozzles have not been replaced with the deflected nozzle group, then the processing similar to that described above is implemented.

At S24, a droplet ejection pattern number which has not yet been searched is selected from the droplet ejection pattern search table, and the procedure then advances to S14.

Above, the case is described in which the dot row is formed in the main scanning direction in accordance with the image data. This processing is repeated sequentially as the paper conveyance time elapses.

In this case, the droplet ejection pattern number selected at S10 or S24 is desirably selected at random on the basis of the paper conveyance time (in other words, the amount of the paper's displacement in the paper conveyance direction). By forming dot columns in the sub-scanning direction by means of a randomly selected deflected nozzle group, rather than a particular deflected nozzle group, it is possible to reduce the visibility of stripes or unevenness in the sub-scanning direction even when the deflected nozzle group contains a nozzle producing landing position displacement.

Although the image forming apparatus according to the present invention has been described in detail above, the present invention is not limited to the aforementioned examples. It is of course possible for improvements or modifications of various kinds to be implemented, within a range which does not deviate from the essence of the present invention.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus, comprising:
a long liquid droplet ejection head in which a plurality of nozzles are arranged;
a conveyance device which attracts a recording medium by means of electrostatic attraction and conveys the recording medium in a sub-scanning direction substantially perpendicular to a main scanning direction;
a dividing device which divides a print region into a plurality of blocks, the blocks including a first blocks and a second blocks situated next to the first blocks in the sub-scanning direction; and
a control device which drives, at a substantially simultaneous drive timing, a plurality of mutually adjacent nozzles corresponding to the plurality of blocks,
wherein a boundary line that divides the print region in the first blocks in the main scanning direction and a boundary line that divides the print region in the second blocks in the main scanning direction are discontinuous from each other in the sub-scanning direction.

2. The image forming apparatus as defined in claim 1, wherein a drive timing of each of the blocks is different from a drive timing of at least another of the blocks situated in the main scanning direction.

3. An image forming apparatus comprising:
a long liquid droplet ejection head in which a plurality of nozzles are arranged;
a conveyance device which attracts a recording medium by means of electrostatic attraction and conveys the recording medium in a sub-scanning direction substantially perpendicular to a main scanning direction; and
a control device which controls drive timing of the nozzles,
wherein, when a solid area comprising at least one of a region of substantially uniform density and a gradation region having a density change is formed on the recording medium, the control device: does drive, at a substantially simultaneous drive timing, a plurality of mutually adjacent nozzles corresponding to a central region that excludes boundary regions comprising edge sections in the main scanning direction of the solid area and vicinity of the edge sections; and does drive the plurality of nozzles corresponding to the boundary regions of the solid area at a drive timing different from a drive timing at which the mutually adjacent nozzles corresponding to the central region are driven.

4. The image forming apparatus as defined in claim 3, wherein the control device changes the drive timing of the nozzles corresponding to the boundary regions with respect to each droplet ejection operation.

5. An image forming apparatus, comprising:
a long liquid droplet ejection head in which a plurality of nozzles are arranged;
a conveyance device which attracts a recording medium by means of electrostatic attraction and conveys the recording medium in a sub-scanning direction substantially perpendicular to a main scanning direction; and
a control device which controls drive timing of the nozzles,
wherein, when a solid area comprising at least one of a region of substantially uniform density and a gradation region having a density change is formed on the recording medium, the control device: does drive, at a substantially simultaneous drive timing, a plurality of mutually adjacent nozzles corresponding to a central region that excludes boundary regions comprising edge sections in the main scanning direction of the solid area and vicinity of the edge sections; does not drive the nozzles corresponding to the edge sections in the main scanning direction of the solid area; and does drive the nozzles corresponding to the vicinity of the edge sections in the main scanning direction of the solid area at a drive timing substantially simultaneous as a drive timing of the nozzles corresponding to the central region of the solid area, and also at a drive timing different from the drive timing of the nozzles corresponding to the central region of the solid area.

6. An image forming apparatus, comprising:
a long liquid droplet ejection head in which a plurality of nozzles are arranged;
a conveyance device which attracts a recording medium by means of electrostatic attraction and conveys the recording medium in a sub-scanning direction substantially perpendicular to a main scanning direction; and
a control device which controls drive timing of the plurality of nozzles,
wherein the control device selects, from the plurality of nozzles, at least one set comprising one nozzle and a first proximate nozzle which ejects a flight liquid droplet which is affected and deflected by forces of electrostatic repulsion when ejected at a drive timing substantially simultaneous as a drive timing of the one nozzle, controls ejection in such a manner that the drive timings of the one nozzle and the first proximate nozzle are substantially simultaneous, and changes selection patterns of the one nozzle and the first proximate nozzle according to conveyance time of the recording medium.

7. The image forming apparatus as defined in claim 6, wherein the control device controls the ejection from the nozzles in such a manner that a drive timing of the nozzles other than the one nozzle and the first proximate nozzle is different from a drive timing of a second proximate nozzle that is arranged closely to the nozzles other than the one nozzle and the first proximate nozzle.

8. The image forming apparatus as defined in claim 6, wherein the control device randomly changes the selection patterns of the one nozzle and the first proximate nozzle according to the conveyance time of the recording medium.

9. The image forming apparatus as defined in claim 6, wherein the control device periodically changes the selection patterns of the one nozzle and the first proximate nozzle according to the conveyance time of the recording medium.

10. An image forming apparatus, comprising:
a long liquid droplet ejection head in which a plurality of nozzles are arranged;
a conveyance device which attracts a recording medium by means of electrostatic attraction and conveys the recording medium in a sub-scanning direction substantially perpendicular to a main scanning direction; and
a droplet ejection substitution device which controls ejection from the nozzles,
wherein in a case where if at least two first nozzles of the nozzles are driven at a substantially simultaneous drive timing, then liquid droplets ejected from the at least two first nozzles of the nozzles land at droplet landing positions on the recording medium that face second nozzles other than the first nozzles of the nozzles: when dots are to be formed at the droplet landing positions on the recording medium that face the second nozzles, the droplet ejection substitution device causes droplets to be appropriately ejected by the first nozzles so as to form the dots.

11. The image forming apparatus as defined in claim 10, further comprising:
a storage device which stores a plurality of droplet ejection patterns for substituting droplet ejection by the first nozzles for droplet ejection by the second nozzles; and
a selection device which selects, in accordance with image data, a desired droplet ejection pattern from the plurality of the droplet ejection patterns stored in the storage device,
wherein the droplet ejection substitution device substitutes the droplet ejection by the first nozzles for the droplet ejection by the second nozzles according to the droplet ejection pattern selected by the selection device.

12. The image forming apparatus as defined in claim 11, wherein the selection device randomly selects the droplet ejection pattern according to conveyance time of the recording medium.
